(19) United States
(12) Patent Application Publication
(10) Pub. No.: US 2009/0271297 A1
(43) Pub. Date: Oct. 29, 2009

(54) MANAGEMENT OF COMMUNICATIONS PURCHASING AND USE

(76) Inventors: Trent Matthew McCracken, Morrow, OH (US); Troy James McCracken, Mason, OH (US)

Correspondence Address: WOOD, HERRON & EVANS, LLP, 2700 CAREW TOWER, 441 VINE STREET, CINCINNATI, OH, 45202, US

(21) Appl. No.: 12/428,240

(22) Filed: Apr. 22, 2009

Related U.S. Application Data
(60) Provisional application No. 61/047,231, filed on Apr. 23, 2008.

(51) Int. Cl. G06Q 10/00; G06F 17/30

(52) U.S. Cl. 705/28; 707/104.1; 707/E17.019; 707/E17.044

(57) ABSTRACT

A system for tracking and presenting communication services consumed by an organization from a plurality of communications service providers is provided. The system includes an invoices data store for information relating to communication services expenses of the organization from two or more separate providers, a services data store for information relating to services approved for use by the organization, and an inventory data store for information relating to communications equipment in use by the organization. The system provides an interface for tracking and presenting the consumption of both wireless and wired communications services, including invoices, services and inventory associated with the wired and wireless communications services.

### CROSS-REFERENCE TO RELATED APPLICATIONS

This application is related to U.S. patent application Ser. No. ______ to Trent McCracken and Troy McCracken, entitled “MANAGEMENT OF COMMUNICATIONS PURCHASING AND USE” (SPENET-02US2) and filed on even date herewith, which application is incorporated by reference herein, and is further related to and claims the benefit of U.S. Patent Application Ser. No. 61/047,231 to Trent McCracken and Troy McCracken entitled “MANAGEMENT OF COMMUNICATIONS PURCHASING AND USE” (SPENET-02P) and filed on Apr. 23, 2008, which application is incorporated by reference herein.

### FIELD OF THE INVENTION

The present invention relates to an online service, and more particularly to a system that provides order processing and asset management, invoice visibility, and unique analytical tools to ensure telecommunications usage accountability within an organization.

### BACKGROUND OF THE INVENTION

In the modern telecommunications environment, organizations (e.g., companies) face significant challenges in managing communication expenses. Employees have need for multiple communication services, including Internet, wired telephone, and wireless telephone services, as well as various other services associated therewith, for use in day-to-day business. These services are typically acquired from multiple unrelated service providers, such as individual Internet service providers, wired telephone communication providers, and wireless telephone communication providers.

The diversity of sources of such services pose a substantial management challenge to an organization. For example, each provider's services are typically not reconcilable with the others or with budgetary goals and constraints. Moreover, each provider generally requires equipment specific to that particular provider to enable the service from said provider. Additionally, analysis of individual usage of the various services from the various providers is an arduous task, and management of the use of the services to meet administrative or budgetary guidelines is often difficult to accomplish without extensive human involvement in the parsing and evaluation of invoices and orders with multiple service providers.

Consequently, there is a need to track, manage and present communication services, and related expenses thereof, to an organization in such a manner that accounts for multiple and different services, multiple and different providers, and multiple and different equipment requirements, among other considerations.

### SUMMARY OF THE INVENTION

Embodiments of the invention provide a system to manage, track and present communication services consumed by an organization. In particular, embodiments of the invention provide for a system to centrally track and present communication services consumed by an organization from a plurality of communication service providers. The system comprises an invoices data store for information relating to communication services expenses of the organization from two or more service providers, a services data store for information relating to services approved for use by the organization, and an inventory data store for information relating to communications equipment in use by the organization. In those embodiments, the system provides an interface for an organization member for viewing of one or more of invoices, services, and inventory specific to that member, and an interface for an organization administrator for viewing one or more of invoices, services and inventory applicable to plural members of the organization.

In alternative embodiments, a system to centrally track and present communication services consumed by an organization from a plurality of communication service providers is provided. The system comprises an invoices data store for information relating to communication services expenses of the organization from two or more service providers, a services data store for information relating to services approved for use by the organization, and an inventory data store for information relating to communications equipment in use by the organization. In those embodiments, the system provides an interface for the tracking and presentation of the consumption of both wireless and wired communications services, including invoices, services and inventory associated with the wired and wireless communications services.

In further alternative embodiments, a system to centrally track and present communication services consumed by an organization from a plurality of communication services providers is provided. The system comprises an invoices data store for information relating to communication services expenses of the organization from two or more service providers, a services data store for information relating to services approved for use by the organization, and an inventory data store for information relating to communications equipment in use by the organization. In those embodiments, the system is configured to import invoices from the plurality of communications services into said invoices data store, and the system further configured to receive first electronic invoice information for the organization from a first communications service and store the first electronic invoice information in the invoices data store associated with to the organization.

In still further alternative embodiments, a system to centrally track and present communication services consumed by an organization from a plurality of communication services providers is provided. The system comprises an invoices data store for information relating to communication services expenses of the organization from two or more service providers, a services data store for information relating to services approved for use by the organization, and an inventory data store for information relating to communications equipment in use by the organization. In those embodiments, the system is configured to import invoices from the plurality of communications services into said invoices data store, the system further configured to receive a paper based invoice for the organization from a communications service, extract electronic invoice information therefrom by character recognition, and store the electronic invoice information in the invoices data store associated with the organization. Moreover, in those embodiments, the system is further configured to generate an image for at least a portion of an imported paper based invoice that is relevant to a particular organization member for storage in said invoices data store.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is diagrammatic illustration of a system that may be used to track, manage and present communication services, and related expenses thereof, consistent with embodiments of the invention;

FIG. 2 is a diagrammatic illustration of components of a database management system of the system of FIG. 1;

FIG. 3 is a diagrammatic illustration of components of a communication management application of the system of FIG. 1;

FIG. 4 is a diagrammatic illustration of components of a database of the system of FIG. 1;

FIG. 5 is a flowchart illustrating a sequence of operations that may be executed by at least a portion of the system of FIG. 1 to import invoice information;

FIG. 6 is a flowchart illustrating a sequence of operations that may be executed by at least a portion of the system of FIG. 1 to receive and process a request for a new service;

FIG. 7 is a flowchart illustrating a sequence of operations that may be executed by at least a portion of the system of FIG. 1 to receive and process a request for an order;

FIG. 8 is a flowchart illustrating a sequence of operations that may be executed by at least a portion of the system of FIG. 1 to receive and process a request to view inventory information;

FIG. 9 is a flowchart illustrating a sequence of operations that may be executed by at least a portion of the system of FIG. 1 to receive and process a request to view carrier information;

FIG, 10 is a flowchart illustrating a sequence of operations that may be executed by at least a portion of the system of FIG. 1 to receive and process a request to view invoice information;

FIG. 11 is a flowchart illustrating a sequence of operations that may be executed by at least a portion of the system of FIG. 1 to receive and process a request to view report information and/or build a custom report;

FIG. 12 is a diagrammatic illustration of an interface, such as a web page, that may be provided to a user by the system of FIG. 1 to view system information;

FIG. 13 is a diagrammatic illustration of an interface, such as a web page, that may be provided to a user by the system of FIG. 1 to view expense information associated with inventory;

FIG. 14 is a diagrammatic illustration of an interface, such as a web page, that may be provided to a user by the system of FIG. 1 to view trends in expense information associated with inventory;

FIG. 15 is a diagrammatic illustration of an interface, such as a web page, that may be provided to a user by the system of FIG. 1 to view invoice summary information associated with inventory;

FIG. 16 is a diagrammatic illustration of an interface, such as a web page, that may be provided to a user by the system of FIG. 1 to view user information associated with a carrier;

FIG. 17 is a diagrammatic illustration of an interface, such as a web page, that may be provided to a user by the system of FIG. 1 to view invoice summary information associated with a carrier;

FIG. 18 is a diagrammatic illustration of an interface, such as a web page, that may be provided to a user by the system of FIG. 1 to view account information associated with at least one invoice;

FIG. 19 is a diagrammatic illustration of an interface, such as a web page, that may be provided to a user by the system of FIG. 1 to view user information associated with at least one invoice;

FIG. 20 is a diagrammatic illustration of an interface, such as a web page, that may be provided to a user by the system of FIG. 1 to select a report to view and/or build a custom report;

FIG. 21 is a diagrammatic illustration of an interface, such as a web page, that may be provided to a user by the system of FIG. 1 to view a report; and

FIG. 22 is a diagrammatic illustration of an interface, such as a web page, that may be provided to a user by the system of FIG. 1 to build a custom report.

It should be understood that the appended drawings are not necessarily to scale, presenting a somewhat simplified representation of various preferred features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments may have been enlarged or distorted relative to others to facilitate visualization and clear understanding.

### DETAILED DESCRIPTION

### Hardware and Software Environment

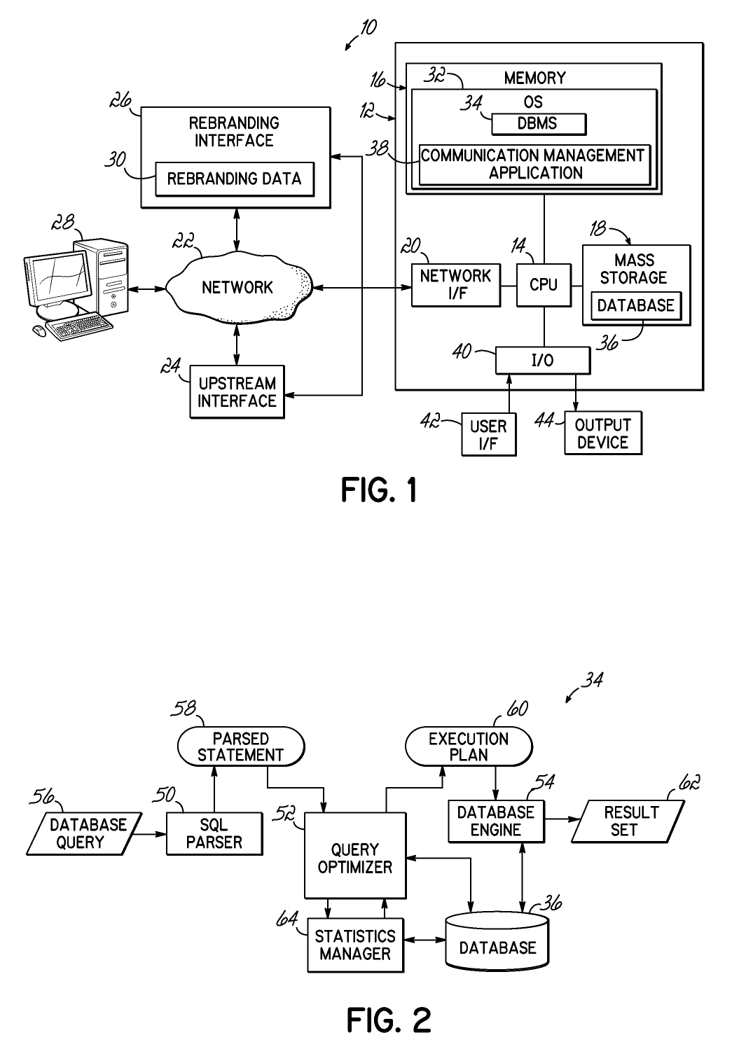

Turning more particularly to the drawings, wherein like numbers denote like parts through the several views, FIG. 1 generally illustrates a system 10 for tracking, managing and presenting communication services, and related expenses thereof, that includes a data processing apparatus 12 consistent with embodiments of the invention. Apparatus 12, in specific embodiments, may be a computer, computer system, computing device, server, disk array, or programmable device such as a multi-user computer, a single-user computer, a handheld device, a networked device (including a computer in a cluster configuration), a mobile phone, a video game console (or other gaming system), etc. Apparatus 12 may be referred to as “computing apparatus,” but will be referred to as “computing system” for the sake of brevity.

The computing system 12 includes at least one central processing unit (“CPU”) 14 (or more simply, “processing unit” 14) coupled to a memory 16. Each CPU 14 may be one or more microprocessors, micro-controllers, field programmable gate arrays, or ASICs, while memory 16 may include random access memory (RAM), dynamic random access memory (DRAM), static random access memory (SRAM), flash memory, and/or another digital storage medium. As such, memory 16 may be considered to include memory storage physically located elsewhere in the computing system 12, e.g., any cache memory in the at least one CPU 14, as well as any storage capacity used as a virtual memory, e.g., as stored on a mass storage device 18, a computer, or another controller coupled to computer through at least one network interface 20 (illustrated as, and hereinafter, “network I/F” 20) by way of at least one network 22.

As illustrated in FIG. 1, the computing system 12 may be communicably coupled with an upstream interface 24 and/or a rebranding interface 26, both of which may be computing systems, either by way of the network 22 or directly. In some embodiments, the computing system 12 is configured to provide information to the upstream interface 24 in response to requests from a client 28. As such, the computing system 12 may provide interfaces configured to be interacted with by the client 28 (e.g., web pages) to the upstream interface 24. To customize those web pages, the rebranding interface 26 may include rebranding data 30 and provide that rebranding data 30 to the upstream interface 24, which may then insert at least a portion of the rebranding data 30 specific to a client 28 into a web page for the client 28. In some embodiments, the rebranding data 30 includes branding data (e.g., text, images, video, flash, etc.) specific to each client 28. As such, the client 28 may be provided personalized web pages that allow them to manage communication expenses.

The computing system 12 may be under the control of an operating system 32 and execute or otherwise rely upon various computer software applications, components, programs, files, objects, modules, etc., consistent with embodiments of the invention. In particular, the computing system 12 may be configured with a database management system 34 (illustrated as, and hereinafter, “DBMS” 34) to interface with and control a database 36, as well as a communication management application 38 configured to track, manage and present communication services information.

The computing system 12 may also include peripheral devices connected to the computer through an input/output device interface 40 (illustrated as, and hereinafter, “I/O I/F” 40). In particular, the computing system 12 may receive data from a user through at least one user interface 42 (including, for example, a keyboard, mouse, a microphone, and/or other user interface) and/or output data to a user through at least one output device 44 (including, for example, a display, speakers, a printer, and/or another output device). Moreover, in some embodiments, the I/O I/F 40 communicates with a device that is operative as a user interface 42 and output device 44 in combination, such as a touchscreen display (not shown).

In some embodiments, the DBMS 34 is configured to execute an operation on the database 36, such as a write, read and/or query consistent with embodiments of the invention. FIG. 2 is a diagrammatic illustration of the principal components of one implementation of the DBMS 34 consistent with embodiments of the invention. The principal components of DBMS 34 that are generally relevant to query execution are a Structured Query Language (SQL) parser 50, query optimizer 52 and database engine 54. SQL parser 50 receives a database query 56 from the client communication management application 38, which in the illustrated embodiment, is provided in the form of an SQL statement. For example, a user of the client 28 may interact with a web page provided by the upstream interface 24 that in turn contains data and/or rebranding data from the respective computing system 12 and/or rebranding interface 26. In turn, the interaction may be converted into a SQL statement by the communication management application 38. The SQL parser 50 then generates a parsed statement 58 therefrom, which is passed to optimizer 52 for query optimization. As a result of query optimization, an execution or access plan 60 is generated. Once generated, the execution plan is forwarded to database engine 54 for execution of the database query on the information in database 36. The result of the execution of the database query is typically stored in a result set, as represented at block 62.

To facilitate the optimization of queries, the DBMS 34 may also include a statistics manager 64. Statistics manager 64 may be used to gather, create, and/or analyze statistical information using database 36 for the query optimizer 52. It will be appreciated by those of ordinary skill in the art, however, that optimizer 52, statistics manager 64, database 36, database engine 54, and/or other components may be accorded different functionality in some embodiments. It will be appreciated by one having ordinary skill in the art that the DBMS 34 may include more or fewer components without departing from the scope of the invention.

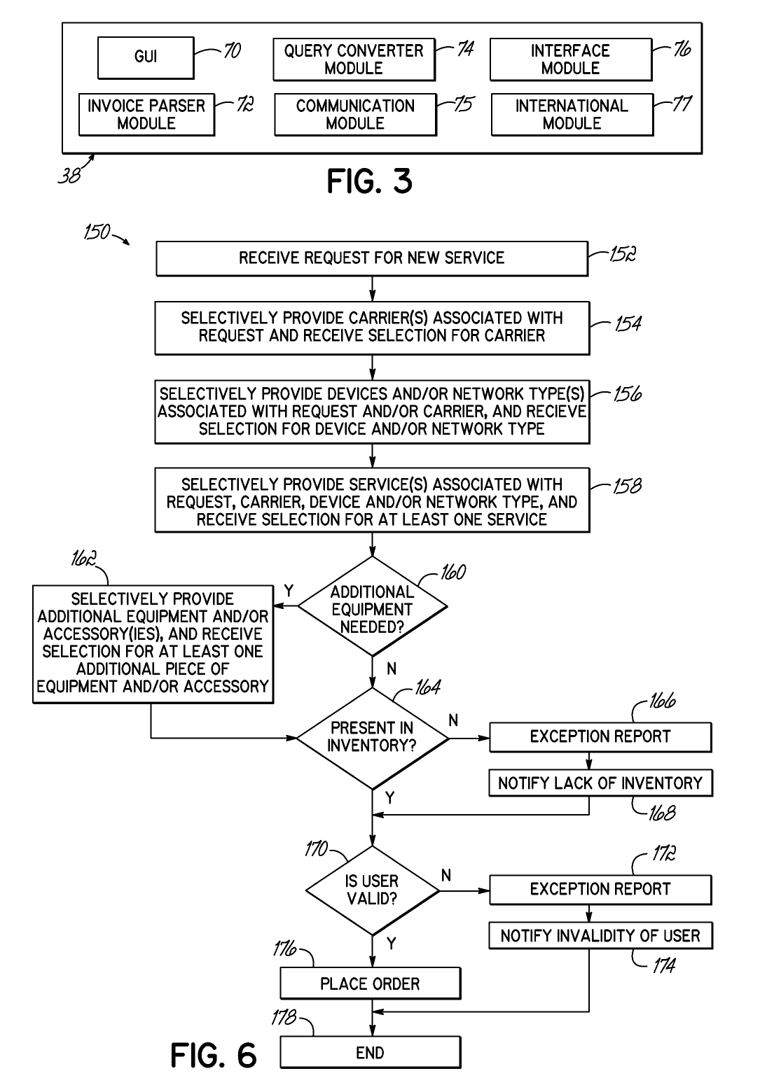

In some embodiments, the communication management application 38 is configured to be controlled to track, manage and present communication services to the client 28. FIG. 3 is a diagrammatic illustration of the principal components of one implementation of the communication management application 38 consistent with embodiments of the invention. The communication management application 38 may include a graphical user interface 70 (illustrated as “GUI” 70) to generate web pages, an invoice parser module 72 to parse an invoice (e.g., an electronic version of a invoice or an invoice that exists in an electronic format) and extract information from that invoice, a query converter module 74 to convert interaction with a web page into a database query or other operation that may be in turn presented to the DBMS 34, and/or a communication module 75 to communicate with at least one of the network 22, upstream interface 24 and/or rebranding interface 26.

Moreover, the communication management application 38 may include an interface module 76 and an international module 77. In some embodiments, the interface module 76 is configured to provide interfaces to the client 28. In specific embodiments, the interface module 76 is configured so selectively provide a plurality of interfaces to the client 28 based upon the identity of the client. For example, a first web page with information related only to a first client 28 may be accessed by that first client 28, while a second web page with information related to a plurality of clients may be accessed by a second client 28, wherein the second client 28 is an administrator. Similarly, a third web page with information related to financial information may be offered to a third client 28, wherein the third client is a chief financial officer. As such, the interface module 76 may determine the identity of the client, and thus provide appropriate interfaces therefor. In some embodiments, the interface module 76 is configured to provide an administrator's web page for a respective administrator to build the plurality of interfaces.

In some embodiments, the international module 77 is configured to convert foreign currencies into domestic currencies, foreign text into domestic text, and otherwise assist in the conversion of invoices in a foreign language to items in a domestic language for storage in the database 36. For example, when the client is based in the United States and an invoice from a foreign country includes a monetary amount that is in pound sterling, the amount may be converted into the United States dollar by the international module 77. Also for example, when the client is based in Great Britain and an invoice from a foreign country is written in French as well as includes a monetary amount that is in the euro, an item of text of the invoice may be converted into English and the amount may be converted into pound sterling by the international module 77. Thus, it will be appreciated by one having ordinary skill in the art that the international module 77 may be configured to convert either text or monetary amounts of an invoice from one language to another or from one dialect of a language to another consistent with embodiments of the invention. Furthermore, it will be appreciated that a conversion factor and/or conversion dictionary for the international module 77 may be updated consistent with embodiments of the invention (e.g., on an hourly, daily, two-day, weekly, monthly basis, etc.).

It will be appreciated by one having ordinary skill in the art that the communication management application 38 may include more or fewer interfaces and/or modules without departing from the scope of the invention. Specifically, and although not illustrated, it will be appreciated that the communication management application 38 may include interfaces configured to access and display information associated with specific tables of the database 36 and/or perform specific actions in response to user interaction with the communication management application 38. For example, the communication management application 38 may include at least one login interface that controls the login and/or logoff of a user, a help interface to provide support to the user, an administrative interface to allow administrators of the system 10 access to administrative tools, an inventory management interface to manage inventory and the presentation of information associated therewith, an order interface to manage orders and the presentation of information associated therewith, an invoice interface to manage invoices and the presentation of information associated therewith, a reporting interface to manage system and/or custom reports as well as the presentation of information associated therewith, and/or an error message interface to provide error messages, among other interfaces.

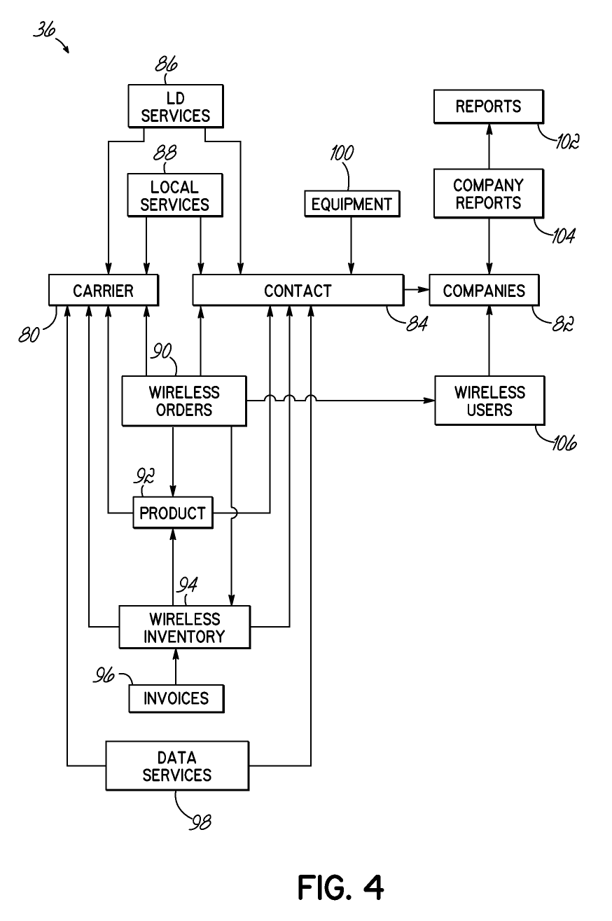

FIG. 4 is a diagrammatic illustration of the principal components of one implementation of the database 36 consistent with embodiments of the invention. Specifically, the database 36 may include a plurality of tables, or data stores, such as a carrier table 80, a companies table 82, and a contact table 84 that may respectively include information associated with a communications carrier, a company and/or organization configured to utilize the system 10, and a contact for that company and/or organization. In some embodiments, the carrier table 80 includes general information about a carrier of long distance, local services and/or wireless services, while the companies table 82 includes general information about a company and/or organization (e.g., a client 28) configured to utilize the system 10 for tracking, managing and presenting their communication services, purchasing and use. In some embodiments, the contact table 84 includes location and/or division information associated with a company and/or an organization (hereinafter, for the sake of brevity, a company and/or an organization will be referred to as a “company”).

In addition to the carrier table 80, companies table 82 and/or contact table 84, the database 36 may be further configured with a plurality of additional tables, or data stores. For example, these additional tables may include a long distance services table 86 (illustrated as, and hereinafter, “LD” services table 86) to store information associated with long distance communication services and expenses thereof for at least one service provider, a local services table 88 to store information associated with local communication services and expenses thereof for at least one service provider, a wireless orders table 90 to store information associated with orders for wireless devices and/or a product table 92 to store information associated with products. Moreover, the database 36 may be configured with a wireless inventory table 94 to store information associated with wireless inventory, an invoices table 96 to store information associated with invoices and/or the invoices themselves, a data services table 98 to store information associated with data communication services and expenses thereof for at least one service provider (e.g., for example, Internet data services, wireless data services, etc.), an equipment table 100 to store information associated with equipment, a reports table 102 to store information associated with reports and/or the reports themselves, a company reports table 104 to link at least one report to a company, and/or a wireless users table 106 to store information associated with wireless users. As such, the database 36 may be configured to store data associated with a company, its users, and/or the various types of communication that company uses (e.g., local, long distance, data, wireless phone and/or wireless data).

In general, the carrier table 80 includes information associated with a carrier of long distance, local services, data services and/or wireless services. For example, the carrier table 80 may include fields associated with the name of the carrier, the type of the carrier, a path to display a logo of the carrier, a link to a website illustrating the coverage area of the carrier, as well as other carrier information. Moreover, and in specific embodiments, the carrier table 80 includes at least one field upon which the LD services table 86, local services table 88, wireless orders table 90, product table 92, wireless inventory table 94 and/or data services table 98 rely to access carrier information (e.g., a “primary key” of the carrier table 80, and a “foreign key” of the tables that use that field to access the carrier table 80). This field may be a unique identification of a carrier, or “CarrierID” field. It will be appreciated by one having ordinary skill in the art that the carrier table 80 may include more or fewer fields, and that those fields discussed above are merely illustrative and not intended to limit embodiments of the invention.

In general, the companies table 82 includes information associated with a company configured to utilize the system 10 to track, manage and present their communication services, purchasing and use. For example, the companies table 82 may include fields associated with the name of the company, an account number, a tax identification number, a bit to indicate whether the company has billable invoices outstanding, a bit to indicate whether the company is sent invoices by e-mail, as well as other company information. Moreover, and in specific embodiments, the companies table 82 includes at least one field upon which the contact table 84, the company reports table 104 and/or the wireless users table 106 rely to access company information (e.g., a “primary key” of the companies table 82, and a “foreign key” of the tables that use that field to access the companies table 82). This field may be a unique identification of a company, or “CompanyID” field. It will be appreciated by one having ordinary skill in the art that companies table 82 may include more or fewer fields, and that those fields discussed above are merely illustrative and not intended to limit embodiments of the invention.

In general, the contact table 84 includes information associated with a company, and in particular includes information about a location and/or division of the company. For example, the contact table 84 may include fields associated with the name of the company, an account number, a tax identification number, at least one contact number (e.g., phone, fax, extensions thereof, etc.), an address for the company (e.g., at least one address line, a city, state/province, county, zip, country, location code, etc.), a contact name, as well as other contact information. Moreover, and in specific embodiments, the contact table 84 includes at least one field upon which the LD services table 86, local services table 88, wireless orders table 90, product table 92, wireless inventory table 94, data services table 98 and/or equipment table 100 rely to access location and/or division information (e.g., a “primary key” of the contact table 84, and a “foreign key” of the tables that use that field to access the contact table 84). This field may be a unique identification of a division, location and/or contact, or “DivisionID” field. It will be appreciated by one having ordinary skill in the art that the contact table 84 may include more or fewer fields, and that those fields discussed above are merely illustrative and not intended to limit embodiments of the invention.

In general, the LD services table 86 includes information associated with long distance phone services in turn associated with a carrier and/or company. For example, the LD services table 86 may include fields associated with a long distance phone number, data associated with a contract for long distance services (e.g., the date signed, the effective date, the term, the cost, the expiration date), intrastate rates, interstate rates, international rates, directory listings (e.g., local and national), billing and/or troubleshooting contact information, routing information (e.g., multi-carrier routing, time of day and/or day of week routing, menu routing, etc.), project information (e.g., a project associated with the long distance service), long distance circuit information (e.g., type of circuit, bandwidth, status, circuit cost, install date, activation date, a unique identification of the circuit, etc.), local exchange carrier (“LEC”) information (e.g., name, unique identification, type, access type, cost, install date, bandwidth, status, etc. of the LEC), protocol associated with the long distance service, a bit as to whether the long distance service is an 8XX number (e.g., an “800” number), as well as other long distance service information. Similarly, and also in general, the local services table 88 includes information associated with local phone services in turn associated with a particular carrier and/or company. For example, the local services table 88 may include fields associated with a local phone number, data associated with a contract for local services (e.g., the date signed, the effective date, the term, the cost, the expiration date), rates, billing and/or troubleshooting contact information, lines and/or channels associated with the local service, protocol associated with the local service, routing information, as well as other local service information. It will be appreciated by one having ordinary skill in the art that the LD services table 86 and/or local services table 88 may include more or fewer fields, and that those fields discussed above are merely illustrative and not intended to limit embodiments of the invention.

In general, the wireless orders table 90 includes information associated with orders for wireless devices that are in turn associated with a carrier, company and/or wireless user. For example, the wireless orders table 90 may include fields associated with an employee and/or manager associated with an order (e.g., user identification, admin user identification, name, number, e-mail, etc.), the submitter of the order, an account associated with the order, a location associated with the order, address information associated with the order (e.g., shipping and/or billing information), an identification of inventory to replace, a reason for replacement of the inventory, minutes to add to a plan, the amount of the order, as well as other wireless order information. Also in general, the products table 92 includes information associated with wireless products that are in turn associated with a carrier and/or company. For example, the products table 92 may include fields associated with a product, signing date for the product, effective date of the product, expiration date of the product, the location to which the product is assigned, the carrier associated with the product and/or notes about the product, as well as other product information. Moreover, and in specific embodiments, the products table 92 includes at least one field upon which the wireless orders table 90 and/or wireless inventory table 94 rely to access wireless product information (e.g., a “primary key” of the products table 92, and a “foreign key” of the tables that use that field to access the products table 92). This field may be a unique identification of a product, or “ProductID” field. It will be appreciated by one having ordinary skill in the art that the wireless orders 90 and/or products table 92 may include more or fewer fields, and that those fields discussed above are merely illustrative and not intended to limit embodiments of the invention.

In general, the wireless inventory table 94 includes information associated with wireless inventory, such as extra inventory or inventory that is being used, that is in turn associated with a carrier and/or company. For example, the wireless inventory table 94 may include fields associated with a product associated with a piece of inventory, a location and/or division associated with a piece of inventory, and a carrier associated with a piece of inventory. The wireless inventory table 94 may further include fields associated with the actual piece of inventory (e.g., a name, a description, etc.), an employee assigned the piece of inventory (e.g., their name, number, e-mail, manager, etc.), the status of the piece of inventory, account information associated with the piece of inventory (e.g., for example, an employee account, a corporate account and/or a general used to purchase the piece of inventory, as well as respective passwords associated therewith), purchase information associated with the piece of inventory (e.g., the purchase date and price, a warranty associated with the piece of inventory, a corporate discount used to purchase the piece of inventory, etc.), a vendor that supplied the piece of inventory, dates associated with the piece of inventor (e.g., for example, the activation date, expiration date, date the piece inventory may be upgraded and/or replaced, date shipped, date received, etc.), a phone number associated with the piece of inventory, a project associated with the piece of inventory (e.g., a project name, the project manager's name and e-mail, etc.), as well as other wireless inventory information. Moreover, and in specific embodiments, the wireless inventory table 94 includes at least one field upon which the invoices table 96 relies to access wireless inventory information (e.g., a “primary key” of the wireless inventory table 94, and a “foreign key” of the tables that use that field to access the wireless inventory table 94). This field may be a unique identification of a piece of wireless inventory, or “WInID” field. It will be appreciated by one having ordinary skill in the art that the wireless inventory table 94 may include more or fewer fields, and that those fields discussed above are merely illustrative and not intended to limit embodiments of the invention.

The invoices table 96 generally includes information associated with invoices and/or invoices themselves that are in turn associated with wireless inventory, and in specific embodiments includes information relating to communication service expenses of a company from at least one service provider. Even further specifically, the invoices table 96 includes information relating to communication service expenses of a company from two or more service providers. In some embodiments, an invoice is an electronic document (e.g., e-mails with invoice information or files with invoice information, such as an electronic document in the .tiff format and/or .pdf format) and the information in the invoice is extracted then stored in the invoice table 96, along with a copy of the invoice. In alternative embodiments, such as when an invoice is a hard-copy document (e.g., a physical document that may be received through the mail), that invoice is scanned into an electronic document (e.g., into the .tiff format and/or .pdf format) and then information in the invoice is extracted and stored in the invoice table, along with an electronic copy of the invoice. It will be appreciated that, in either embodiment, the pages of the invoice may be singulated before they are stored. In the event that information from an invoice cannot be extracted, the information may be entered by hand. The invoices table 96 may include fields associated with information about an invoice (e.g., a carrier, name, item, group, location/division associated with the invoice, etc.), a cell phone associated with a portion of the invoice, the portion of the invoice associated with the cell phone, charges (e.g., typical usage charges, additional usage charges, credits, direct connect charges, monthly recurring charges, taxes, other charges, etc.), information associated with minutes (e.g., minutes in plan, minutes imported, voice/data/text minutes used, remaining voice/data/text minutes, etc.), information associated with calls (e.g., calls made, calls received, direct connects made, direct connects received, other counts, etc.), as well as other invoice information. It will be appreciated by one having ordinary skill in the art that the invoices table 96 may include more or fewer fields, and that those fields discussed above are merely illustrative and not intended to limit embodiments of the invention.

The data services table 98 generally includes information associated with data services in turn associated with a carrier and/or company. For example, the data services may include Internet services provided by an Internet service provider (“ISP”) (e.g., a carrier) and/or wireless data services associated with a wireless service provider. For example, the data services table 98 may include fields associated with a type of data service request (e.g., an order type, a service type, etc.), a host, dates (e.g., the date the service is created, the date the service is edited, the date a contract is signed, effective dates associated with a contract, the expiration date of a contract, the term of a contract, an installation date, an activation date, a service date, etc.), whether a site is hosted, carrier information (e.g., the name of the carrier, whether the carrier is a specific type or brand of carrier, such as an LEC, an interexchange carrier, a managed network solutions carrier, a data carrier and/or a wireless carrier, whether the carrier is specific to a particular implementation, such as that the carrier is an ATM carrier, an international carrier and/or a service carrier, etc.), carrier account information (e.g., a carrier account number, carrier billing contacts, the monthly cost of the account, etc.), carrier contact information (e.g., the name, address, e-mail, phone number and/or fax number of a carrier, including dedicated trouble contact information for the carrier), information associated with the circuit provided by the carrier (e.g., an identification of the circuit, including an identification of the circuit type, method of access, loop type, bandwidth availability, whether it is international, as well as circuit speeds, etc.), information about access to the data service (e.g., port speeds, bandwidth, whether the access is burstable, primary DNS, secondary DNS, whether IP addresses are dynamic or static, whether IP addresses are serial or not, IP subnet masks, IP default gateways, the access type to the data service, a user name and password, etc.), the type of data service (e.g., wireless, DSL, the type of DSL, cable, a T-carrier, fiber, etc.), vendor information associated with the data service (e.g., an identification, contact, number, fax, cell, and e-mail of a contact, as well as an identification of the type of the vendor, etc.), data link connection information associated with the data service, network design information associated with the data service (e.g., a network design document, an approval number, an engineer, the engineer's number, contact information for the engineer, etc.), notes, as well as other data services information. It will be appreciated by one having ordinary skill in the art that the data services table 98 may include more or fewer fields, and that those fields discussed above are merely illustrative and not intended to limit embodiments of the invention.

The equipment table 100 generally includes information associated with equipment, and more specifically equipment that may not be either wireless inventory or a product. For example, the equipment table 100 may include fields associated with an identification of the equipment (e.g., a unique identification of the equipment as well as the type of equipment, name, model identification, serial number, and version of the equipment, etc.), an order of the equipment (e.g., an order or order type, the purchase date, the purchase price, a warranty, a vendor associated with the order, etc.), a contract associated with the equipment (e.g., a customer number, a contract number, a contract term, a contract amount, the date a contract was signed, the expiration date of a contract, etc.), notes, as well as other equipment information. It will be appreciated by one having ordinary skill in the art that the equipment table 100 may include more or fewer fields, and that those fields discussed above are merely illustrative and not intended to limit embodiments of the invention.

The reports table 102 generally includes information associated with reports and/or the reports themselves. As such, the reports table 102 may include information associated with system generated reports and/or custom reports. For example, the reports table 102 may include fields associated with a path for a report (e.g., a location to a report), a group report identification (in the event that a report is one of a group of a reports), a designation whether the report is custom, a custom report identification (if the report is custom), information concerning the type of report, and an identification of a company associated with the report. Moreover, and in specific embodiments, the reports table 102 includes at least one field upon which the company reports table 104 relies to access report information (e.g., a “primary key” of the reports table 102, and a “foreign key” of the tables that use that field to access the reports table 102). This field may be a unique identification of a report, or “ReportID” field. It will be appreciated by one having ordinary skill in the art that the reports table 102 may include more or fewer fields, and that those fields discussed above are merely illustrative and not intended to limit embodiments of the invention.

The company reports table 104 generally includes information to link at least one report to a company. For example, the company reports table 104 may include fields associated with an identification of a company and an identification of a report, among other information. It will be appreciated by one having ordinary skill in the art that the company reports table 104 may include more or fewer fields, and that those fields discussed above are merely illustrative and not intended to limit embodiments of the invention.

Finally, the database 36 may include a wireless users table 106 that generally includes information associated with users. For example, the wireless users table 106 may include fields associated with a name of a user (e.g., first and last name), their password, their contact information (e.g., phone number and e-mail), the expiration date of their wireless contract, whether the user has seen the license agreement for a service contract, the access level allowed to the wireless user, whether the user has access to view information for all users, locations and/or divisions of a company, the most recent activity of the user (e.g., last login, last phone called, last web-page visited, last activity, etc.), as well as other user information. Moreover, and in specific embodiments, the wireless users table 106 includes at least one field upon which the company wireless orders table 90 relies to access wireless user information (e.g., a “primary key” of the wireless users table 106, and a “foreign key” of the tables that use that field to access the wireless users table 106). This field may be a unique identification of a user, or “UserID” field. It will be appreciated by one having ordinary skill in the art that the wireless users table 106 may include more or fewer fields, and that those fields discussed above are merely illustrative and not intended to limit embodiments of the invention.

Those skilled in the art will recognize that environments illustrated in FIGS. 1-4 are not intended to be limit embodiments of the invention. For example, and with reference to FIG. 1, the network 22 may include at least one network or a plurality of networks to couple computing system to upstream interface 24 and rebranding interface 26, as well as couple upstream interface 24 to client 28. As such, computing system 12, upstream interface 24 and/or rebranding interface 26 may be communicably coupled through a first network, while upstream interface 24 and client 28 may be communicably coupled through a second network. It will be appreciated that the first network may be a private network while the second network may be a public network, such as the Internet. Similarly, it will be appreciated by one having ordinary skill in the art that the system 10 may include more than one computing system 12, upstream interface 24, rebranding interface 26 and/or client 28. In specific embodiments, the system 12 may include a plurality of at least one of the computing system 12, upstream interface 24, rebranding interface 26 and/or client 28 without departing from the scope of the invention.

Also for example, at least one of the computing system 12, upstream interface 24, rebranding interface 26 and/or client 28 may be configured on a public network, such as the Internet. As such, client 28 may be configured to communicate with the upstream interface 24, which may be a server configured to provide web pages to the client 28. In turn, the upstream interface 24 may be configured to communicate with the computing system 12 and the rebranding interface 30. Moreover, and in alternative embodiments, it will appreciated that the operation of the upstream interface 24 and/or rebranding interface 26 may be combined with the operation of the computing system 12. As such, the computing system 12 may be in direct communication with the client 28 through the network 22 rather than through the upstream interface 24 consistent with embodiments of the invention.

Moreover, it will be appreciated by one having ordinary skill in the art that the DBMS 34, the database 36, and the communication management application 38 may include more or fewer components than those illustrated in respective FIG. 2, FIG. 4 and FIG. 3. For example, the database 36 may include more or fewer tables than those illustrated in FIG. 4, and in particular may include tables that combine one or more tables illustrated in FIG. 4. For example, the LD services table 86, local services table 88 and/or data services table 98 may be combined into a “services” table configured to store information relating to services approved for use by a company, while the product table 92, wireless inventory table 94 and/or equipment table 100 may be combined into an “inventory” table to store information relating to communication equipment in use by the organization table. Moreover, while some of the tables of the database 36 have been referred to as being associated with a carrier and/or company, it will be appreciated by one having skill in the art that the information in said tables may further be associated with a user, employee and/or member of a company as well. Additionally, it will be appreciated that the names of the tables of the database 36 are merely illustrative and not intended to be limiting. For example, the wireless users table 106 may contain information about all users, not just wireless users. Thus, those having skill in the art will recognize that other alternative hardware and/or software environments may be used without departing from the scope of the invention. As such, one having ordinary skill in the art will recognize that the environments illustrated through FIGS. 1-4 are not intended to limit the scope of embodiments of the invention. Therefore, other alternative hardware and/or software environments may be used without departing from the scope of the invention.

The routines executed to implement the embodiments of the invention, whether implemented as part of an operating system or a specific application, system, sequence of operations, component, program, object, module or sequence of instructions executed to manage communications consistent with embodiments of the invention will be referred to herein as a “sequence of operations” or “program code.” The program code typically comprises one or more instructions that are resident at various times in various memory and storage devices in the system 10 and that, when read and executed by one or more processing units and/or CPUs of the computing system 12 and/or interface 24 and/or 26, cause that computing system 12 and/or interface 24, 26 to perform the steps necessary to execute steps, elements, and/or blocks embodying the various aspects of the invention.

While the invention has and hereinafter will be described in the context of fully functioning computing systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and nonvolatile memory devices, floppy and other removable disks, hard disk drives, optical disks (e.g., CD-ROM's, DVD's, Blu-Ray discs, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

### Software Description and Flows

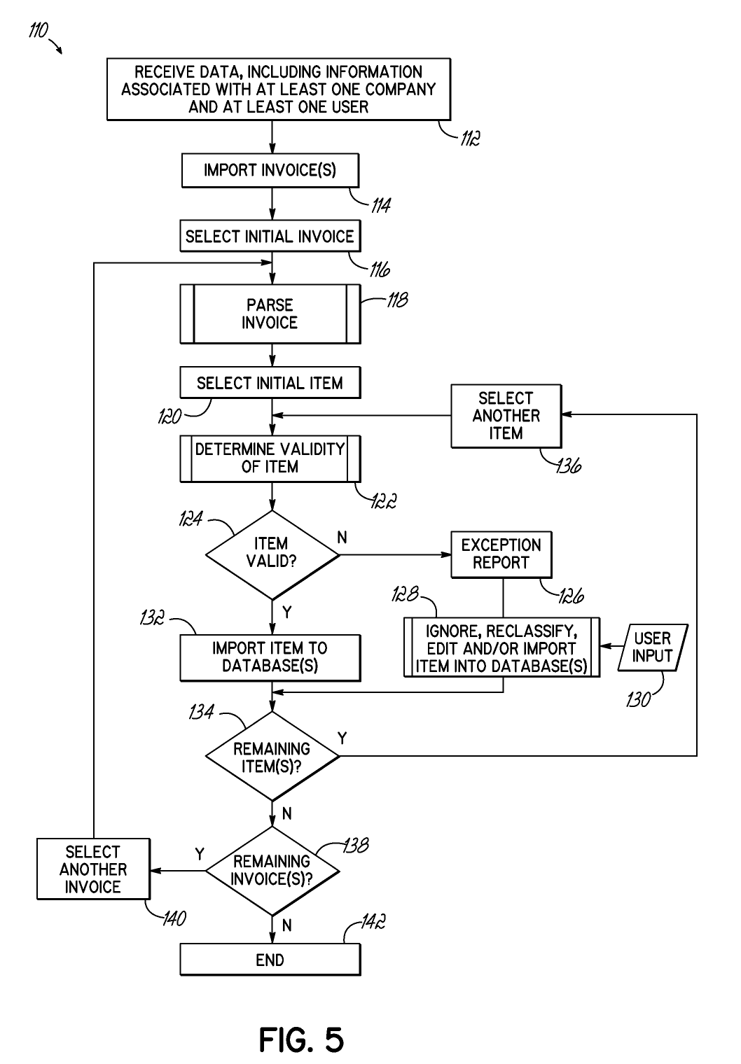

FIG. 5 is a flowchart 110 illustrating a sequence of operations that may be executed by a computing system to extract information from an invoice consistent with embodiments of the invention. Initially, data that includes information associated with at least one company and at least one user may be received (block 112). Specifically, this information may be entered during registration to allow the user to access a communication management application consistent with embodiments of the invention. Thus, after registration, one or more invoices may be imported (block 114) and at least one invoice may be initially selected (block 116). In various embodiments, an invoice may be configured in an electronic format (e.g., an electronic document) or in at least one physical document (e.g., the invoice includes at least one physical paper). In the event that an invoice is configured in an electronic format, importing that invoice may include saving at least a portion of that invoice in a format capable of being parsed to extract information therefrom (e.g., in a .pdf and/or .tiff format, or in another electronic document format, and in specific embodiments in an image file format). In the event that an invoice is configured in at least one physical document, importing that invoice may include scanning the invoice into a format capable of being parsed to extract information therefrom (e.g., in a .pdf and/or .tiff format, or in another electronic document format, and in specific embodiments an image file format). Thus, selecting the at least one initial invoice may include selecting one or more pages of an invoice in a .pdf format, .tiff format, and/or in another electronic document format.

As such, the selected invoice is parsed to extract information (block 118). In specific embodiments, an invoice may be parsed with a parser (e.g., an invoice parser module) that includes a character recognition algorithm to break the invoice down into its constituent parts, and extract a plurality of items of data. An item of data may include at least a portion of a line of characters of an invoice, and specifically at least a portion of a line of characters of an invoice associated with data that corresponds to information configured to be stored in the database. For example, at least a portion of a line of an invoice may be associated with the total data services charge from a carrier and read “Total Data Charges: $819.80.” The parser may therefore be configured to determine that at least a portion of an item is “$819.80” and/or “819.80,” which is in turn associated with the total data charges for a company from a carrier. It will be appreciated that the parser may be configured to recognize various items of an invoice based on previous iterations of parsing invoices and/or based upon a template of the invoice that identifies items in the invoice to the parser. Specifically, the parser may be configured to recognize items that correspond to information configured to be stored in the database and appropriately classify that information.

With reference back to FIG. 5, an initial item of the invoice may be selected (block 120) and the validity of the item may be determined (block 122). In some embodiments, the validity of the item is determined with reference to an expected type of data associated with a particular item. For example, when it is determined that an item is associated with numbers (e.g., for example, and not intending to be limiting, an item of the invoice is associated with a monetary charge), then that item may be invalid when it contains an alphabetical character (e.g., the item contains one or more of the letters “a” through “z”). Similarly, when it is determined that an item is associated with one or more alphabetic characters, then that item may be invalid when it contains a number. As such, when an item is invalid (“No” branch of decision block 124) an exception report may be generated and/or an entry about the item may be added to an existing exception report (block 126) and the item may be ignored, reclassified, edited and/or imported into at least one database (block 128). In some embodiments, the item may be reclassified and/or edited with reference to user input (block 130). For example, upon determining an item is invalid the user may be queried as to the item and provided with a display representation of the portion of an invoice that the item was captured from. The user may then input a new classification of the item and/or edit the item. As an example, the parser may parse a number and mistakenly place a period (“.”) where they should be a comma (“,”). The user may then edit the item to replace the period with a comma. Similarly, and also for example, the parser may parse the invoice and select an item that has no corresponding database entry (e.g., for example, a legal paragraph at the bottom of an invoice). The user may then classify the item as unnecessary. When an item is classified as necessary and/or edited, the item may be imported into the database, and in specific embodiments to an appropriate table and field of the database. When an item is classified as unnecessary, the item may be ignored.

When the item is valid (“Yes” branch of decision block 124), the item may be imported into the database, and in specific embodiments to an appropriate table and field of the database (block 132). In response to importing the item into the database (block 132) or in response to reclassifying, editing and/or importing the item into the database (block 128), it may then be determined whether there is at least one item of the invoice remaining to be validated and/or imported (block 134). When there is at least one item of the invoice remaining to be validated and/or imported (“Yes” branch of decision block 134), an additional item may be selected (block 136) and the sequence of operations 110 may return to block 122 to determine the validity of the item. When there is not at least one item of the invoice remaining to validated and/or imported (“No” branch of decision block 134), it may be determined whether there is at least one remaining invoice to parse (block 138). When there is at least one remaining invoice to parse (“Yes” branch of decision block 138) another invoice may be selected (block 140) and the sequence of operations 110 may proceed to block 118 to parse that invoice. When there is not at least one remaining invoice (“No” branch of decision block 138) the sequence of operations 110 may end (block 142). Thus, it will be appreciated that an invoice may be received, broken down into its constituent parts, and those parts may undergo quality assurance before being uploaded to a corresponding portion of a database. It will be appreciated that, in some embodiments, the invoices are stored in the database as well. As such, an invoice may be stored in whole or in part, and, when stored in part, the pages of an invoice may be singulated and stored individually. In this manner, and in response to user interaction to view at least a portion of an invoice, the page upon which that portion is disposed may be displayed. Specifically, only the page upon which that portion is disposed may be provided to be displayed, or the entire invoice may be provided to be displayed and the display may resolve to that page upon which the portion is disposed.

FIG. 6 is a flowchart illustrating a sequence of operations 150 that may be executed by a computing system to receive and process a request for a new service consistent with embodiments of the invention. The sequence of operations 150 may be executed to order a new phone service and/or data service, whether wired or wireless. As such, a request for a new service may be received (block 152). In response to this request for new service, at least one carrier associated with the request may be selectively provided, and a selection for a carrier for the service may be received (block 154). In some embodiments, the provided carrier that is associated with the request is specific to the type of service requested. For example, when the new service is a wireless phone and/or data service the carrier is a wireless phone and/or data service provider (e.g., Sprint, Verizon, AT&T, etc.), while when the new service is a terrestrial (e.g., wired) Internet service the carrier is a terrestrial ISP. In specific embodiments, at least one carrier is selectively provided based upon whether that carrier providing services for the company, location and/or user. For example, a first company may only use a first carrier for a particular service, while a second company may use a plurality of carriers for that same service, wherein that plurality of carriers includes that first carrier as well as a second carrier. As such, the first carrier may be selectively provided to the first company to select from for a new service, but the second carrier may not be provided. Similarly, at least the first carrier and the second carrier may be selectively provided to the second company to select from for a new service.

In response to the selection of a carrier, at least one device and/or network type associated with the request and/or the selected carrier may be selectively provided, and a selection for a device and/or network type may be received (block 156). For example, at least one device from a plurality of devices may be selectively displayed based upon devices that a company may wish to display (e.g., on a cost basis, on a bulk order basis, on the basis of inventory, on the basis of compatibility with the request for service, on the basis of compatibility with a selected carrier, etc.), and at least one network type from a plurality of network types may be selectively displayed based upon network types that a company may wish to display (e.g., on a cost basis, on a bulk contract basis, on the basis of compatibility with the request for service, on the basis of compatibility with a selected carrier, etc.). In response to the selection of a device and/or network type, at least one service may be selectively provided, and a selection for a service may be received (block 158). Thus, at least one service from a plurality of services may be displayed based upon the services that a company may wish to display (e.g., on a cost basis, on a bulk contract basis, on the basis of compatibility with the request for service, on the basis of compatibility with a selected carrier, on the basis of compatibility with a selected device and/or network type, etc.). For example, if a user requests a new wireless phone, a plurality of wireless phone service plans and/or wireless data service plans may be displayed. For a more specific example, the various wireless phone service plans may include indications of the numbers of minutes associated with the various wireless phone service plans, while the various wireless data service plans may include indications of the rates and level of accessibility with the various wireless data service plans. Thus, a company may display only certain types of services (e.g., local phone services, long distance phone services, data services, wireless phone services, wireless data services, etc.), as well as certain specific services (e.g., various rate based local and/or long distance services, bandwidth and/or access based data services, minutes based wireless phone services, direct connect wireless phone services, bandwidth and/or access based wireless data services, etc.).

In response to a selection of at least one service, it may be determined whether additional equipment associated with the requested service, the selected carrier, the selected device and/or network type, and/or the selected service is needed (block 160). For example, if a company is located in a jurisdiction that requires wireless phone users to use a wireless headset while driving, the company may determine that users located in that jurisdiction should be issued a wireless headset. When an additional piece of equipment and/or accessory is needed (“Yes” branch of decision block 160), the company may selectively provide at least one additional piece of equipment and/or accessory, and receive a selection for at least one additional piece of equipment and/or accessory (block 162). When an additional piece of equipment and/or accessory is not needed (“No” branch of decision block 160) and/or after a selection of at least one additional piece of equipment and/or accessory has been received (block 162), it may be determined whether the selected device, piece of equipment and/or accessory is present in inventory associated with the company (block 164).

When the selected device, piece of equipment and/or accessory is not present in inventory (“No” branch of decision block 164), an exception report may be generated and/or an entry about the lack of the selected device, piece of equipment and/or accessory in inventory may be added to an existing exception report (block 166), and a notification about the lack of inventory may be issued (block 168). For example, the notification of the lack of inventory may be sent to a person who procures inventory for a company, to the user who requested new service, to an administrative user and/or to a user who is otherwise associated with the request. When the selected device, piece of equipment and/or accessory is present in inventory (“Yes” branch of decision block 164) and/or after a notification that the selected device, piece of equipment and/or accessory is not in inventory (block 168), it may be determined whether a user associated with the request is valid (block 170). When a user associated with the request is invalid (“No” branch of decision block 170) an exception report may be generated and/or an entry about the invalidity of a user may be added to an existing exception report (block 172), and a notification of the invalidity of the user may be issued (block 174). For example, the notification of the invalidity of a user may be sent to a manager of the user, to the user who requested new service and/or to an administrative user. When the user associated with the request is valid (“Yes” branch of decision block 170), the order may be placed (block 176). In response to the notification of the invalidity of a user (block 174) and/or in response to the placement of an order (block 176), the sequence of operations may end (block 178).

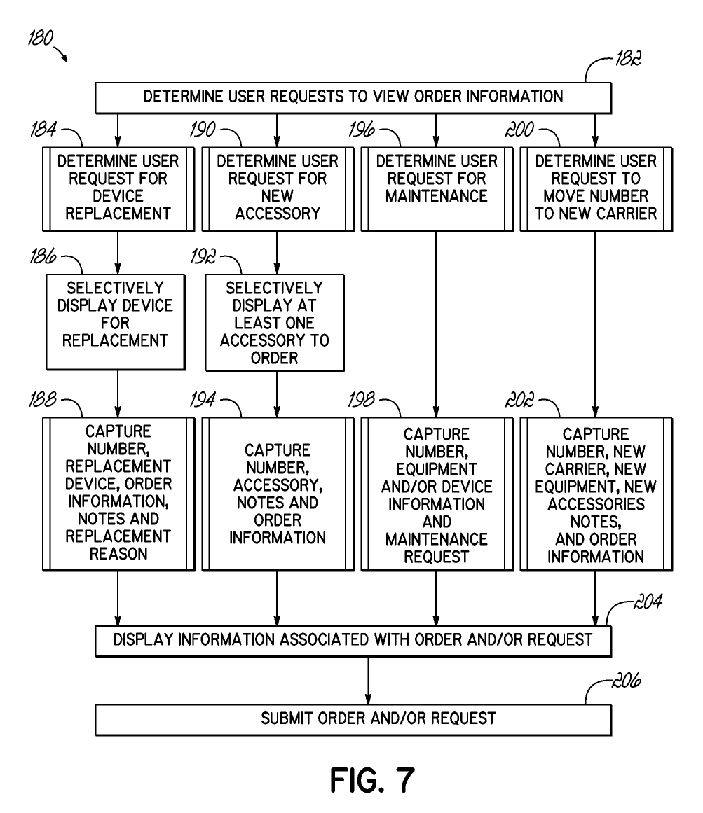

FIG. 7 is a flowchart illustrating a sequence of operations 180 that may be executed by a computing system to process a user request to view order information consistent with embodiments of the invention. In specific embodiments, it is determined that a user interacts with a web page to request to view order information, such as to request a new number and/or service, request a replacement device, request a new accessory, request maintenance, and/or request to move a number to a new carrier (block 182). When it is determined that a new number and/or service is requested, a sequence of operations such as that illustrated in FIG. 6 may be executed. Returning to FIG. 7, when it is determined that a user requests for the replacement of a device (block 184), at least one device for replacement is selectively displayed (block 186). For example, at least one device from a plurality of devices may be selectively displayed based upon devices that a company may wish to display (e.g., on a cost basis, on a bulk order basis, on the basis of inventory, on a compatibility with services basis, on a compatibility with a network the replacement device will interface with, etc.). As such, the number associated with the request (e.g., a phone number), along with an identification of the replacement device, order information (such as the identity of the person requesting the replacement device, the identity of their manager, the identity of the person who will receive the replacement device, where to ship the replacement device, an account to charge, etc.) notes about the request and/or a reason for the replacement (e.g., damaged, lost, stolen, upgrade, equipment failure, other, etc.) is captured (block 188).

When it is determined that a user requests a new accessory (block 190), at least one accessory is selectively displayed for the user to order (block 192). For example, at least one accessory from a plurality of accessories may be selectively displayed based upon accessories that a company may wish to display (e.g., on a cost basis, on a bulk order basis, on the basis of inventory, on a compatibility with devices basis, etc.). As such, the number associated with the request (e.g., a phone number), along with an identification of the accessory, notes about the request and/or order information (such as the identity of the person requesting the accessory, the identity of their manager, the identity of the person who will receive the accessory, where to ship the accessory, an account to charge, etc.) are captured (block 194).

When it is determined that a user requests maintenance (block 196) the number associated with the request (e.g., a phone number), along with information about the equipment and/or device associated with the maintenance request, as well as the maintenance request itself are captured (block 198). Similarly, when it is determined that a user requests to move a number to a new carrier (block 200), the number associated with the request, the identification of the new carrier, a selection of new equipment that may be required, a selection of at least one new accessory that may be required, notes about the request and/or order information (such as the identity of the person requesting the number transfer, the identity of their manager, the identity of the person whose number is subject to the transfer, an account to charge, etc.) are captured (block 202). In response to capturing information (blocks 188, 194, 198 and/or 202) order information associated with an order and/or request may be displayed for the user to confirm the information (block 204). Upon confirmation, the order and/or request may be submitted electronically (block 206).

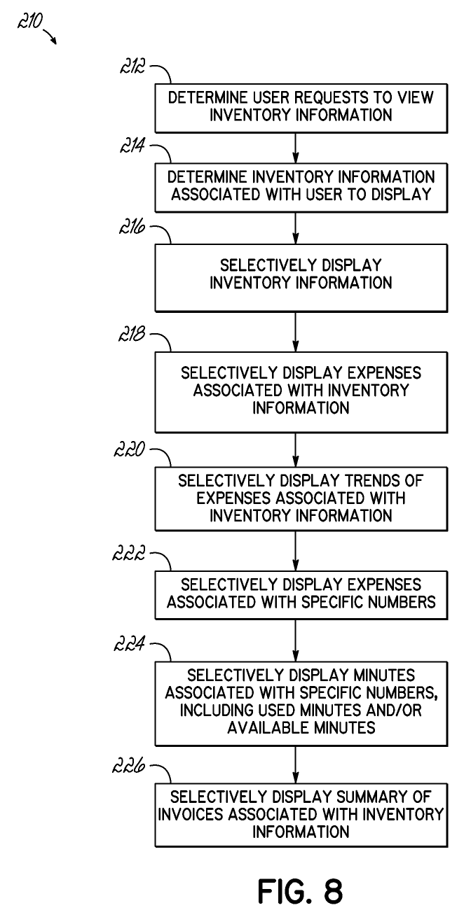

FIG. 8 is a flowchart illustrating a sequence of operations 210 that may be executed by a computing system to selectively display information associated with an inventory consistent with embodiments of the invention. For example, it may be determined that a user requests to view information associated with inventory (block 212) and, as such, the inventory information that is associated with the user is determined (block 214). For example, the inventory information that is associated with the user may include inventory information associated with a company that is in turn associated with the user, as well as inventory information that the user is allowed to view. It will be appreciated that the inventory information associated with the user may include inventory information extracted from one or more invoices from one or more carriers, thus allowing the user to track, manage and view inventory information for an entire company. As such, the inventory information associated with the user that may be displayed is selectively displayed (block 216). In some embodiments, expenses associated with the inventory information are selectively displayed (block 218). For example, the expenses selectively displayed may include an indication of the total expenses by carrier within the last billing cycle, the total expenses by carrier within a time period (e.g., by year and/or by month range) and/or the total expenses by carrier associated with a particular location of a company. In some embodiments, the expenses are illustrated as a bar graph showing the various expenses per carrier, while in alternative embodiments the expenses are illustrated as a pie chart showing the relative percentage of the expenses to the total expenses per carrier.

In addition to displaying the expenses, trends of the expenses associated with inventory information may also be selectively displayed (block 220). For example, a start date and end date may be selected, and a graph displaying expense trends over that selected data range may be generated. Also, expenses associated with specific numbers may be selectively displayed (block 222). For example, the ten numbers associated with the most expenses, in relation to other numbers, may be displayed in regards to the last billing cycle, the total expenses within a time period (e.g., by year and/or by month range) and/or the total expenses for numbers associated with a particular location of a company. The expenses associated with specific numbers may be illustrated as a bar graph showing the various expenses per number and/or as a pie chart showing the relative percentage of the expenses to the total of the ten expenses with a key showing the numbers associated with those expenses. Moreover, and also in relation to specific numbers, minutes of plans associated with numbers may also be selectively displayed, including used minutes and/or remaining minutes of the plan associated with those numbers (block 224). For example, the ten numbers associated with the usage of the most minutes, in relation to other numbers, may be displayed in regard to the last billing cycle, the total minutes within a time period (e.g., by year and/or by month range) and/or the total minutes for numbers associated with a particular location of a company may be selectively displayed. The used minutes associated with specific numbers may be illustrated as a bar graph showing the various minutes per number and/or as a pie chart showing the relative percentage of the minutes to the total of the ten number's minutes with a key showing the numbers associated with those minutes. Alternatively, the remaining minutes of various numbers may be selectively displayed consistent with alternative embodiments of the invention.

In addition to expenses, trends thereof, and minutes of numbers, a summary of invoices associated with inventory information may also be displayed (block 226). For example, the summary of invoices may include information extracted from a plurality of invoices from a plurality of carriers for a specific location of a company. Thus, for a location, this summary may include an indication of the total monthly service charges, taxes, adjustments (e.g., credits, discounts, etc.), overages, an indication of the count of numbers associated with that location, the total number of minutes used and/or other charges. It will be appreciated that the inventory information, expenses, expense trends, expenses associated with specific numbers, minutes associated with specific numbers, and summary of invoices may be specific to a particular location of a company.

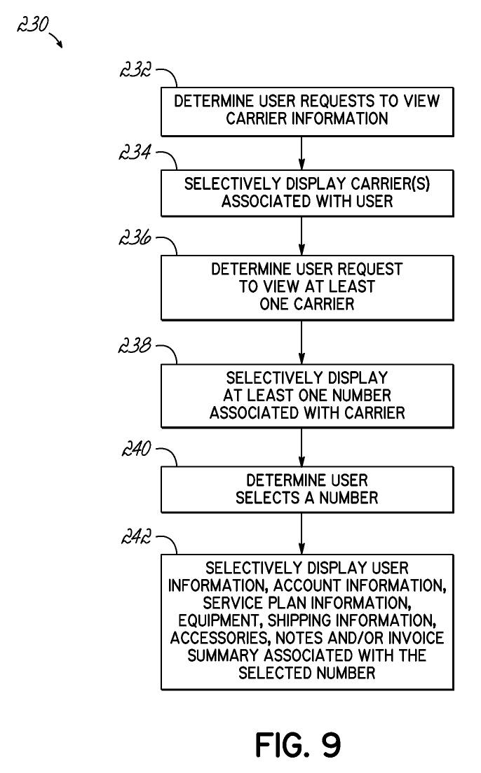

FIG. 9 is a flowchart illustrating a sequence of operations 230 that may be executed by a computing system to selectively display information associated with a carrier consistent with embodiments of the invention. For example, it may be determined that a user requests to view information associated with at least one carrier (block 232) and, as such, information associated with at least one carrier that is in turn associated with the user may be selectively displayed (block 234). In turn, it may be determined that a user selects at least one carrier to view additional information related to that at least one carrier (block 236). Thus, additional information related to the selected carrier, including at least one number associated with the carrier, may be selectively displayed (block 238). For example, each number associated with the selected carrier that is in turn associated with the user may be listed, along with information about each number. To view more information about a particular number, a user may select a number and, upon a determination that the user selects a number (block 240), information about the number, including user information, account information, service plan information, equipment associated with the number, shipping information about the number, accessories associated with the number, notes about the number and/or an invoice summary associated with the selected number may be selectively displayed (block 242). In some embodiments, the information associated with the carrier and the number (e.g., including the user information, account information, service plan information, equipment associated with the number, shipping information about the number, accessories associated with the number, notes about the number and/or an invoice summary associated with the number) is extracted from at least one invoice consistent with embodiments of the invention.

FIG. 10 is a flowchart illustrating a sequence of operations 250 that may be executed by a computing system to selectively display information associated with at least one invoice consistent with embodiments of the invention. Thus, it may be determined that a user requests to view information associated with at least one invoice (block 252) and, in response to that determination, information associated with the at least one invoice may be selectively displayed (block 254). Specifically, information associated with the at least one invoice that may be displayed include general invoice information (e.g., for example, the name of the carrier that provided the at least one invoice, the account name for the at least one invoice, the account number of the at least one invoice, the date the at least one invoice was mailed, the total amount of the at least one invoice, the date the total amount is due, etc.), a billing summary (e.g., for example, the previous balance, credits to the previous balance, total current charges, any outstanding balance, costs of the invoice broken up by categories such as data services, phone services, messaging service, direct connection services, and/or other charges, such as equipment charges, rental charges, taxes, credits for this invoice, etc.), and/or an equipment and shipping summary (e.g., for example, equipment charges for equipment orders and/or shipping charges for that equipment, etc.), all of which may be based upon information extracted from the at least one invoice (block 254).

In some embodiments, a user may interact with at least a portion of the equipment and shipping summary, and in specific embodiments an entry (e.g., an equipment and/or shipping charge) of the equipment and shipping summary (block 256). In some embodiments, this interaction includes clicking and/or hovering over that entry. When a user interacts with an entry of the equipment and shipping summary (“Yes” branch of decision block 256) additional information associated with that entry (e.g., a user name, number, and/or account number associated with that entry in the equipment and shipping summary, etc.) is displayed (block 258). When the user does not interact with an entry of the equipment and shipping summary (“No” branch of decision block 256) it may be determined whether the user interacts with at least a portion of the general invoice information, and in specific embodiments, a link to an electronic copy of at least a portion of the invoice (block 260). When the user interacts with the link to the electronic copy (“Yes” branch of decision block 260), an electronic copy of at least a portion of the invoice associated with the general information of the invoice is displayed (block 262). It will be appreciated that the electronic copy may include an image file (e.g., a .pdf image, a .tiff image, etc.) of at least one page of the invoice. In some embodiments, to display the electronic copy, a singulated page is provided and displayed, while in alternative embodiments at least a portion of the invoice is provided and the page associated with the general information is displayed, while in further alternative embodiments the entire invoice is provided and the page associated with the general information is displayed. When the user does not interact with the link to the electronic copy (“No” branch of decision block 260), it may be determined that a user requests to view information associated with charges to at least one individual user, and thus information associated with charges to at least one individual user may be selectively displayed (block 264).

In response to displaying information associated with charges to at least one individual user, it may be determined whether a user interacts with at least a portion of the information associated with the at least one individual user, and in specific embodiments a graphical selection to display additional information about charges of the user and/or a link to an electronic copy of at least a portion of the invoice associated with that individual user (block 266). When it is determined that a user interacts with at least a portion of the information associated with at least one individual user (“Yes” branch of decision block 266), specific charges to at least one individual user may be selectively displayed in response to the user interaction when the user requests to display additional information about charges through the graphical selection (block 268) and/or an electronic copy of the at least a portion of the invoice associated with the individual user may be selectively displayed in response to the user interaction when the user selects the link to the electronic copy of the invoice associated with that individual user (block 270). For example, when additional information about charges is selectively displayed, information associated with monthly recurring charges, credits, taxes, additional usage charges, other charges, minutes and/or other usage of a service associated with that individual user may be displayed. Also for example, and similar to block 262, to display the electronic copy of the at least a portion of the invoice associated with the individual user, a singulated page associated with the charges to the individual user may be provided and displayed, at least a portion of the invoice associated with the charges to the individual user may be provided and the first page associated with the charges to the individual user may be displayed, and/or the entire invoice may be provided and the first page associated with the charges to the individual user may be displayed.

When it is determined that the user does not interact with at least a portion of the information associated with at least one individual user (“No” branch of decision block 266) the sequence of operations 250 may continue monitoring for requests from the user to view invoice information and/or user interaction with invoice information (not shown), or the sequence of operations 250 may end (block 272).

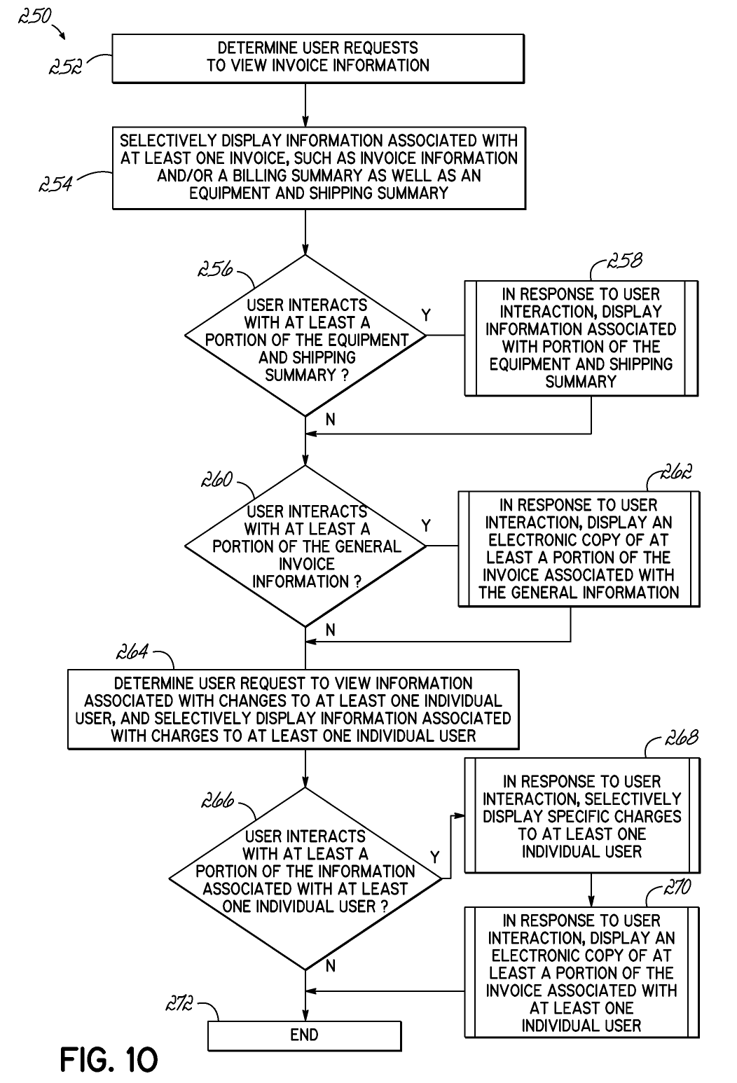

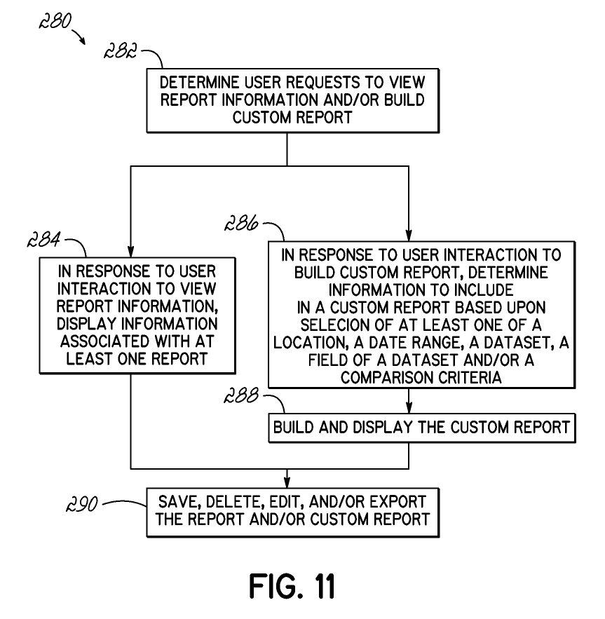

FIG. 11 is a flowchart illustrating a sequence of operations 280 that may be executed by a computing system to selectively display reports and/or build custom reports consistent with embodiments of the invention. Specifically, a user may request to view information associated with a report and/or custom report (block 282) and, in response, information associated with at least one report may be displayed (block 284). In some embodiments, information associated with a report and/or custom report may include financial information, inventory information and/or information about a company, location and/or user thereof, as well as custom information and/or a combination thereof. For example, the information associated with a report and/or a custom report may include information about overages, charges for particular services, usage summaries, taxes, other expenses, other services rendered and/or other custom data. In some embodiments, the system may be configured to automatically build a plurality of reports in response to receiving information extracted from at least one invoice.

Alternatively, a user may request to build a custom report (block 282) and, in response to user interaction to build that custom report, information to include in the custom report may be determined from interaction to select at least one of a location, a date range, a dataset, at least one field of the dataset and/or comparison criteria (block 286). In response to the selection of at least one criteria, a custom report may be built and displayed (block 288). In response to displaying at least one report and/or a custom report (e.g., blocks 284 and/or 288), the report and/or the custom report may be saved, deleted, edited and/or exported (block 290).

Further details and embodiments of the invention will be described by way of descriptions of the following display representations.

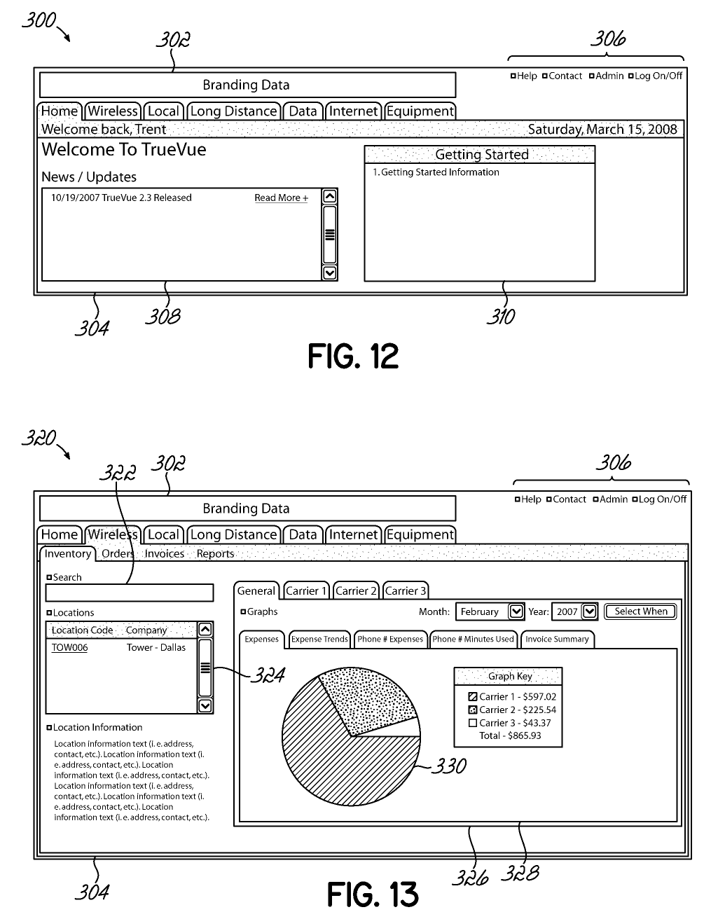

FIG. 12 is a display representation of a welcome screen 300 that may be provided for the user (e.g., a client) to view and manage information about communications services of a company, a division and/or a user thereof consistent with embodiments of the invention. Moreover, the welcome screen 300 also illustrates a number of features of a web page that may be provided to the user to track, manage and view communication services, and related expenses thereof. Specifically, the welcome screen 300 illustrates that web pages provided by a system consistent with embodiments of the invention may include branding date 302 specific to the user, as well as a menu 304 from which to select information associated with a home page, wireless services, local services, long distance services, data services, internet services and equipment. Additionally, the web page may include various links (collectively, 306) that allow the user to view help topics and information, contact an administrator, log in as an administrator and/or log on or off. In some embodiments, the welcome screen 300 may include news and/or outline updates to the system as at 308, as well as give basic information about the system as at 310.

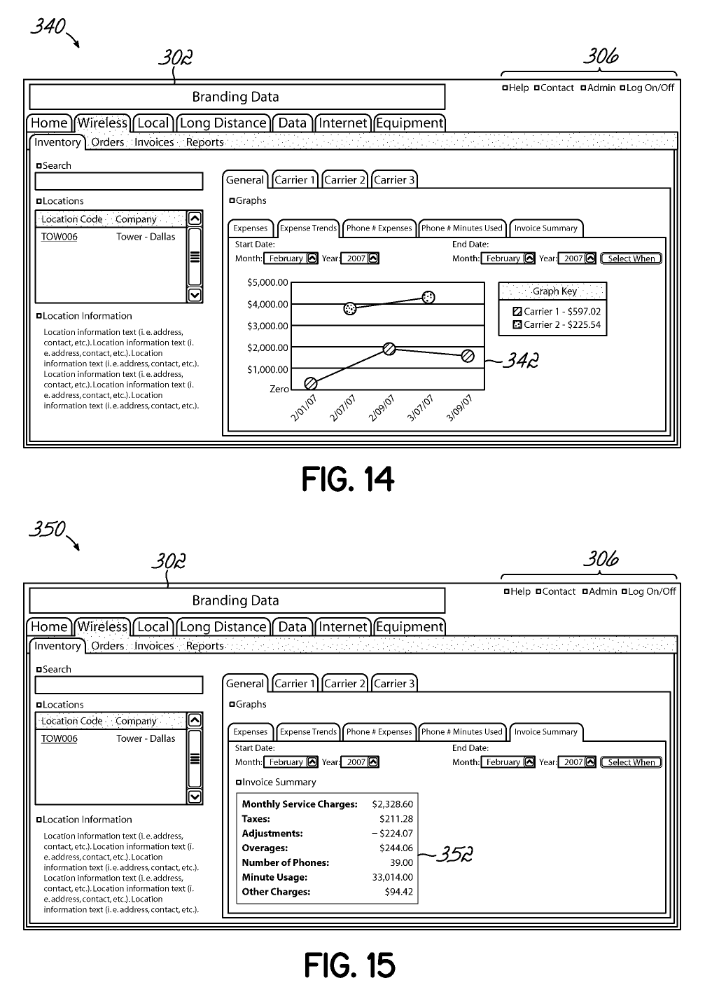

FIG. 13 is a display representation of an inventory screen 320 that may be provided for the user to view inventory information consistent with embodiments of the invention. More specifically, FIG. 14 illustrates a wireless inventory expenses screen 320 associated with wireless inventory of a company, location and/or user thereof consistent with embodiments of the invention. Specifically, the inventory screen 320 illustrates that web pages provided by a system consistent with embodiments of the invention may include a search bar 322 in which the user may search for information and a location menu 324 in which a user may select a location of a company in order to view inventory information related to that location. The inventory screen 320 may further include a carrier selection menu 326 and/or an inventory expenses menu 328. In some embodiments, the carrier selection menu 326 provides the user with a menu to select information associated with one or more carriers, while the inventory expenses menu 328 provides the user with a menu to view more specific inventory information about the selected one or more carriers, including expenses, expense trends, expenses associated with phone numbers, minutes used by phone numbers and/or invoice summaries. For example, FIG. 13 illustrates that the user has selected to view general inventory information for at least two carriers as well as view the general expenses thereof. As such, general inventory information associated with the at least two carriers (e.g., the total cost of the general inventory information associated with the at least two carriers) is presented in a graphic 330 consistent with embodiments of the invention. Although the general inventory information of the at least two carriers is illustrated within as a pie chart in graphic 330, it will be appreciated that the general inventory information may be presented in a bar graph consistent with alternative embodiments of the invention. In some embodiments, the graphic 330 is dynamically created in response to user interaction to select a month, year and/or date range for the expenses information in the graphic 330. As such, the program code for the system may be configured to analyze stored expense data for at least one carrier and display that information consistent with embodiments of the invention.

FIG. 14 is a display representation of an expense trend screen 340 that may be provided for the user to view trends in expenses of inventory consistent with embodiments of the invention. In some embodiments, the trends in expenses of inventory may be illustrated in a graphic 342. As such, the user may view trends for expenses of inventory over time. In some embodiments, the graphic 342 is dynamically created in response to user interaction to select a month, year and/or date range for the trends in the graphic 342. As such, the program code for the system may be configured to analyze multiple instances of stored expense data for at least one carrier and display that information consistent with embodiments of the invention. FIG. 15 is a display representation of an inventory invoice summary screen 350 to display general information associated with at least one invoice consistent with embodiments of the invention. In some embodiments, an invoice summary 352 may be provided in the inventory invoice summary screen consistent with embodiments of the invention. The invoice summary 352 may include summary information of the charges from one or more carrier, and in specific embodiments at least two carriers. Specifically, the invoice summary 352 may include information associated with monthly service charges, taxes, credits and/adjustments, charges associated with overages of users minutes, messaging and/or data plans, the total number of users associated with the invoice summary, the total number of minutes used by users associated with the invoice summary, as well as other charges. Moreover, the invoice summary 352 may be specific to a particular year, month and/or date range, or simply be associated with the most recent month. It will be appreciated by one having ordinary skill in the art that expenses associated with particular users, as well as wireless minutes usage of particular users, may also be displayed without departing from the scope of the invention.

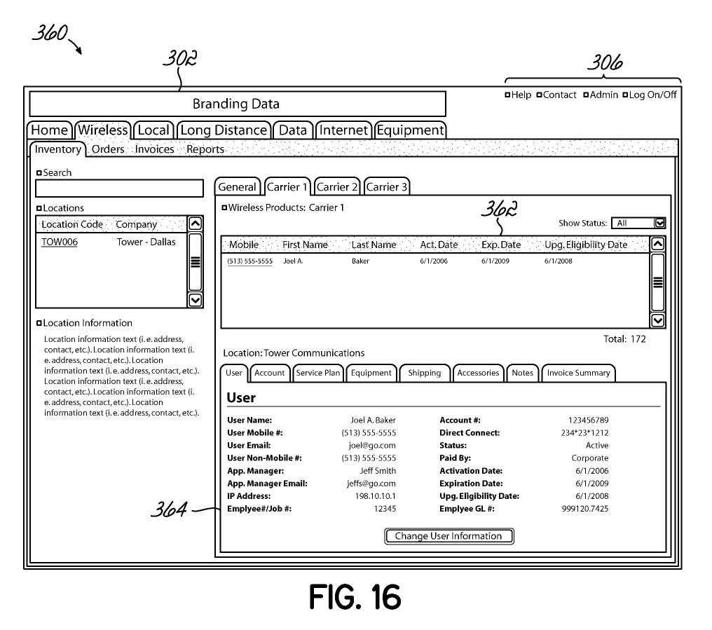

FIG. 16 is a display representation of a carrier inventory screen 360 to display information associated with a carrier, and in particular at least one user of a carrier, consistent with embodiments of the invention. As illustrated in FIG. 16, the user has selected to view information associated with a carrier (e.g., “Carrier 1”) from the carrier selection menu 326 to view information associated with at least one user configured with a service plan through that carrier. In turn, the carrier inventory screen 360 may display general information associated with at least one user configured with a service plan through the carrier in the user selection menu 362 and, in response to a user selection of that user, display more detailed information associated with the user in a user information module 364. For example, the user selection menu 362 may display a name and/or number associated with a user of a service from the carrier. As illustrated in FIG. 16, the user selection menu 362 illustrates the name and phone number of a wireless phone of a user. The user selection menu 362 may also display the initial date of the service, the expiration date of the service and/or the date upon which the service and/or equipment may be updated. Upon selection of an entry (e.g., a user) in the user selection menu 362, the user information module 364 may be configured with information about the user, including their name, a number associated with the account, e-mail, contact information, manager, e-mail of the manager, an IP address associated with the user, their employee number and/or job number, account number, direct connect information, status, who paid for the service, the activation date, the expiration date, the date upon which the service and/or equipment may be updated, and/or other information associated with the selected user. It will be appreciated that additional information about the selected user may be displayed by interacting with the user information module 364. For example, account information, service plan information, equipment information, shipping information, accessories information, notes and/or an invoice summary associated with the user may be viewed by selecting appropriate portions of the user information module 364.

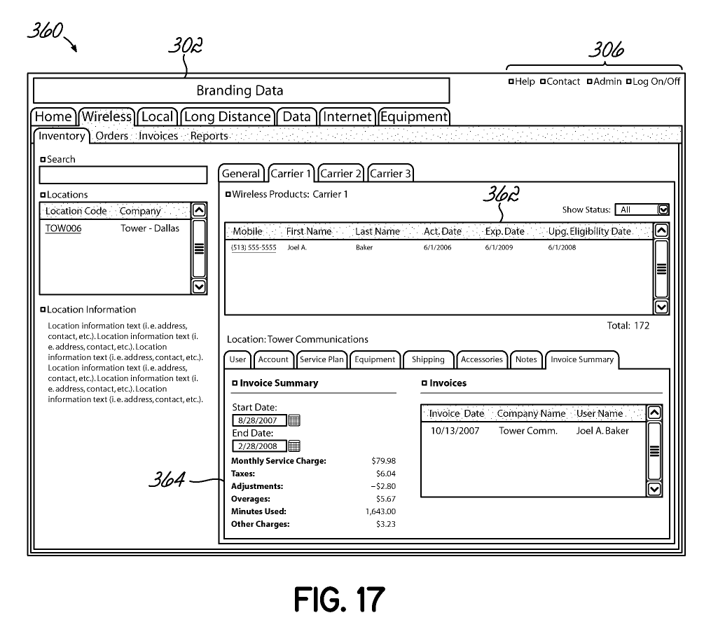

For example, FIG. 17 is a display representation of the carrier inventory screen 360 in which a summary of information from an invoice associated with a user and in turn associated with a carrier is displayed in the user information module 364. For example, and as illustrated in FIG. 17, the monthly service charge, taxes, credits and/or adjustments, minutes used and other charges that are associated with a selected user are displayed in the user information module 364. Moreover, a year, a month, a date and/or a range of dates for a summary may be selected and the respective invoice summaries for invoices associated with those dates, selected user and carrier may be combined and displayed.

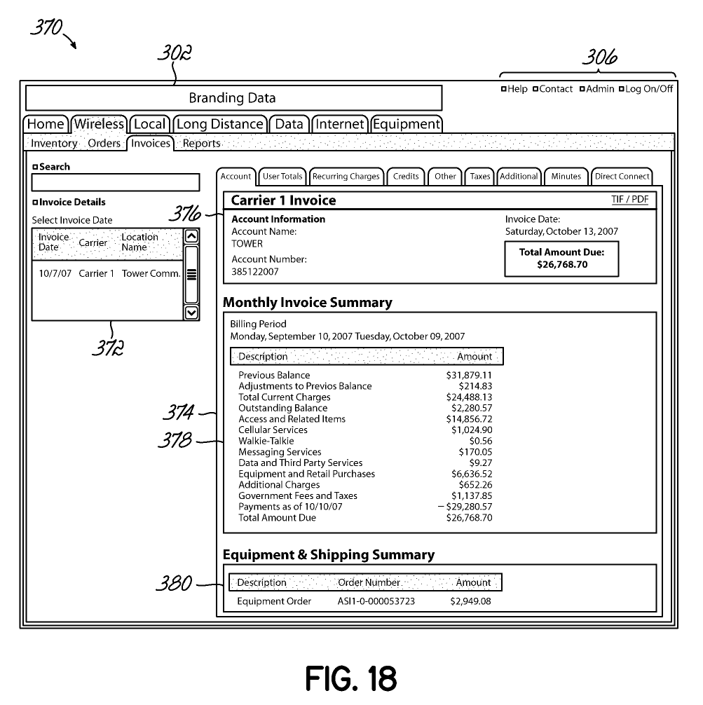

In addition to information associated with inventory, information associated with at least one invoice may also be displayed separate from inventory information. For example, FIG. 18 is a display representation of an invoice information screen 370 configured to provide information associated with at least one invoice. The invoice information screen 370 illustrates that web pages may include an invoice selection menu 372 and an invoice information selection menu 374. In response to a selection of an invoice, the invoice information selection menu 374 may, in turn, provide a user with general information about a carrier associated with a selected invoice in an general invoice information module 376, summary information about the selected invoice in an invoice summary module 378, and information about equipment and/or shipping associated with the selected invoice in an equipment and shipping summary module 380. As such, a user may view information associated with a selected invoice, and more particularly general information about a selected invoice consistent with embodiments of the invention.

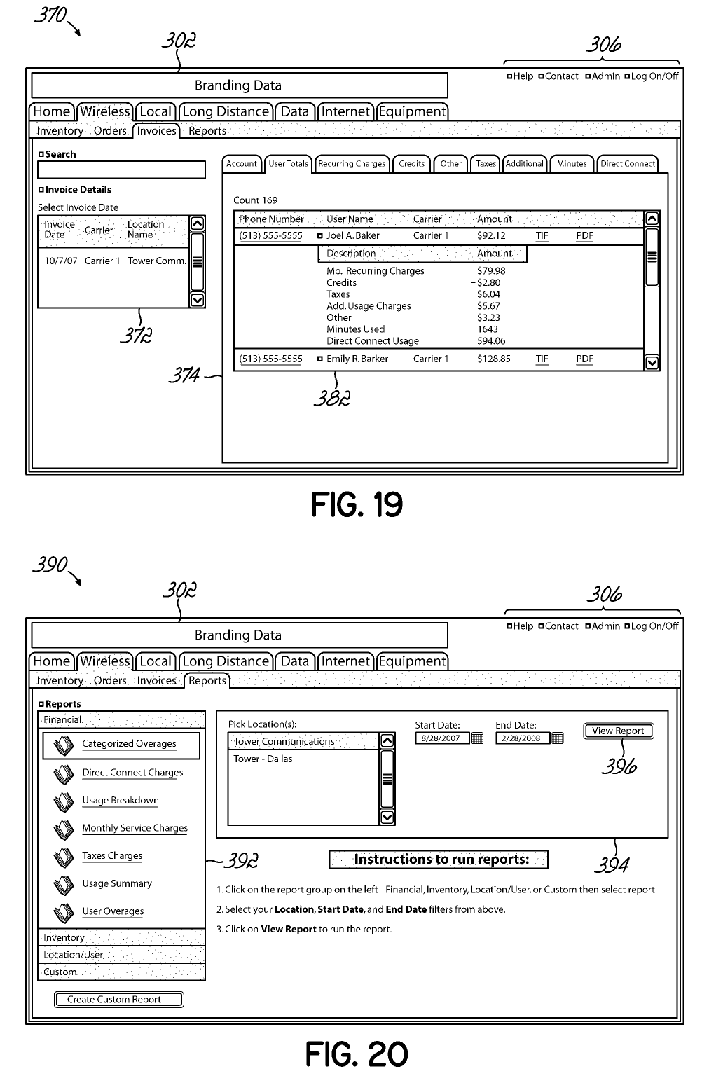

In addition to general information, the invoice information selection menu 374 may be further configured to display more specific information about a selected invoice, including user totals, recurring charges, credits and/or adjustment, other charges, taxes, additional information, minutes and/or direct connection information associated with the selected invoice. For example, FIG. 19 is a display representation of the invoice information screen 370 in which the user has selected to view user totals associated with the selected invoice. As such, the invoice information selection menu 374 includes a list of users 382 associated with a selected invoice. In some embodiments, a user interacts with an entry (e.g., a user) of the list of users 382 to view additional information about that user. For example, and as illustrated in FIG. 19, an entry associated with a first user in the list of users 382 has been expanded to view a breakdown of at least some of the charges associated with that first user. Specifically, the monthly recurring charges, credits and/or adjustments, taxes, additional usage charges, other charges, minutes used, and direction connection minutes used may be displayed.

Although not illustrated in FIG. 18 and FIG. 19, it will be appreciated that additional information may be displayed in the invoice information selection menu 374. For example, information associated with recurring charges, credits and/or adjustments, other charges, taxes, additional charges, minutes and/or direct connection services may also be displayed.

FIG. 20 is a display representation of a report selection screen 390 in which information associated with at least one report and/or custom report may be displayed. Moreover, the report selection screen 390 also illustrates a number of features of a web page that may be provided to the user to view reports and/or custom reports, as well as build custom reports. As such, the report selection screen 390 may include a report selection menu 392 from which to select categories of reports (e.g., financial reports, inventory reports, location/user reports, custom reports) as well as specific reports (e.g., for example, and as illustrated, financial reports associated with categorized overages, direct connection charges, service usage, monthly service charges, taxes, usage summaries and/or user overages, etc.) to view, or “run.” Moreover, the report selection screen 390 may include a report building module 394 in which the user may select a location to view reports and/or custom reports associated with that location, as well as to specify a date range to view reports and/or custom reports associated with that date range. As illustrated in FIG. 20, the user has selected to view a financial report, and more particular a categorized overage financial report in the report selection menu 392, as well as specified a location and date in the report building module 394. To view, a selected report associated with a selected location and specified date range, the user may select the “View Report” button 396 in the report building module. In response to a user selection to view a report, the report may be generated based upon user selection in the report selection menu 392 and report building module 394, then displayed. FIG. 20 is a display representation of a report screen 400 that illustrates at least a portion of a report 402 that may be displayed to the user in response to selecting to view a report and/or build a custom report. Specifically, the report 402 may be displayed in an electronic format, such as an image file format, and in specific embodiments the report may be displayed in a .pdf format or a tiff format. As illustrated, the report 402 may include a report menu 404 and an information section 406. The report menu 404 may be interacted with to view report information, while the information section 406 may display information associated with selections of the report menu 404.

FIG. 22 is a display representation of a custom report screen 410 in which a custom report may be built consistent with embodiments of the invention. In particular, FIG. 22 illustrates a custom report creation module 412 that may be displayed in response to a user request to create a custom report by selecting a “Create Custom Report” button 414. The custom report creation module 412 may be used to name a report, select a dataset for the custom report, select a field of the dataset to use in the custom report, and pick fields for comparison. The report may be viewed by selecting the “Show Report” button 416, saved by selecting the “Save Report” button 418, or deleted by selecting the “Delete Report” button 420.

While embodiments of the present invention have been illustrated by a description of the various embodiments and the examples, and while these embodiments have been described in considerable detail, it is not the intention of the applicants to restrict or in any way limit the scope of the appended claims to such detail. Additional advantages and modifications will readily appear to those skilled in the art. For example, orders and/or requests submitted by a user may be subject to approval. As such, an approving manager may be notified of any order and/or request. Specifically, the approving manager may be sent an e-mail regarding an order and/or request, or be notified of an order and/or request upon logging in. In turn, a link may be displayed to a web page that displays information associated with the order and/or request. As such, the approving manager may select the link and deny, modify or accept the order and/or request. In some embodiments, the approving manager modifies the order and/or request by substituting at least a portion of the order and/or request. In specific embodiments, an order and/or request involves a request for a new wireless phone. The approving manager may modify the order and/or request to specify that the user receives a different wireless phone than the requested wireless phone (e.g., the requested wireless phone is too expensive, and the newly specified wireless phone is less expensive). In response to the denial, modification or acceptance of the order and/or request, fields and/or tables associated therewith may be updated appropriately. It will be appreciated that, in alternative embodiments, a user profile includes an indication whether an order and/or request by that user must be approved, such that, if the indication indicates that if that user's orders and/or request do not need to be approved, an order and/or request by that user is automatically approved and processed upon submission.

Moreover, an interface for configuring alerts based upon rules may also be provided. For example, a rule may include providing an indication associated with when a long distance service associated with a location is set to expire. As such, an administrator may set up the rule such that, on a date that the long distance service is set to expire and/or on a date in advance of the expiration (e.g., by specifying the DD/MM/YYYY of the expiration), an alert is generated and e-mailed to one or more users. Also for example, a rule may include providing an indication associated with when a user is removed, such as in the event of that user's termination, resignation and/or death. The administrator may set up the rule such that, upon an indication of the user's termination, resignation and/or death, an alert is generated and e-mail to one or more users. As such, those users may begin removing services and/or expenditures associated with the user. It will be appreciated by one having skill in the art that the administrator may configured the alerts as appropriate. [00100] Also for example, and with respect to FIG. 5, it will be appreciated by one having skill in the art that reclassification and/or editing performed by the user may be used in subsequent iterations to determine the validity of an item and/or to automatically edit an item. Moreover, and with respect to FIG. 8, it will be appreciated that the flowchart may be used for other data, and should not be limited to inventory information. Furthermore, it will be appreciated that the information displayed to a user may be dependent on that use being allowed to view that information. For example, a first web page may be provided to a user to view only information specific to that user, while a second web page may be provided to an administrative user to view information specific to a plurality of members. Additionally, information may be selectively displayed based upon the identity of the user. For example, financial, inventory, forecasting, trending and analytical information may be selectively displayed on custom configured web pages for various users, such as a Chief Financial Officer (“CFO”), an IT manager, another executive, an administrator, etc. Moreover, the web pages for those various users (e.g., the CFO, IT manager, executive, administrator, etc.) may include different menus, selections, layouts and/or dashboards. Thus, any of the information selectively displayed may be selectively displayed based upon whether a user is allowed to view that information. Moreover, a layout of a web page may be selectively provided based upon the user. Additionally, it will be appreciated that information displayed to the user, information that is included in a report and/or information that is part of a graphic may include information extracted from the at least one invoice consistent with embodiments of the invention.

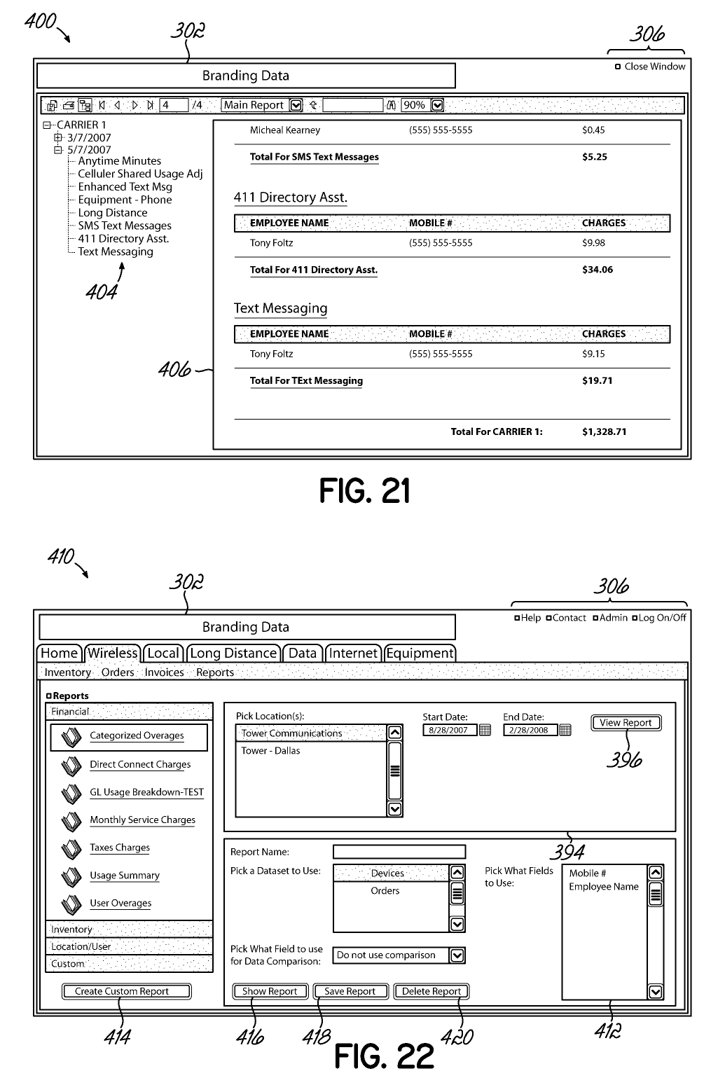

Thus, the invention in its broader aspects is therefore not limited to the specific details, representative apparatus and method, and illustrative example shown and described. In particular, any of the blocks of the above flowcharts may be deleted, augmented, made to be simultaneous with another, combined, or be otherwise altered in accordance with the principles of the present invention. For example, although at least some blocks in FIGS. 5-11 are shown as being executed sequentially, one having ordinary skill in the art will appreciated that any of the blocks may be executed concurrently and/or dependent upon a particular user interaction consistent with embodiments of the invention. Moreover, although some illustrative screens are illustrated in FIGS. 12-22, these screens are merely exemplary and not intended to limit embodiments of the invention. Specifically, alternative screen layouts, graphics, images, and textual information may be selectively displayed consistent with embodiments of the invention. For example, and although not shown, one having ordinary skill in the art will appreciate that information associated with local services, long distance services, data services, internet services and/or equipment therefor may be also be selectively displayed. This includes information associated with inventory, orders, invoices and/or reports, as well as general information and information specific to a particular carrier. Moreover, the information that may be selectively displayed further includes expense information, expense trends, expenses associated with specific phone numbers, minutes used by phone numbers, invoice summaries, as well as user information, account information, service plan information, equipment information, shipping information, accessory information, notes and/or an invoice summary specific to a user. Finally, the information that may be selectively displayed further includes account information, user totals, recurring charges, credits, other charges, taxes, additional charges, minutes and/or direct connection information specific to a carrier. Accordingly, departures may be made from such details without departing from the spirit or scope of applicants' general inventive concept.

Other modifications will be apparent to one of ordinary skill in the art. Therefore, the invention lies in the claims hereinafter appended.

What is claimed is:

1. A system for centralized tracking and presentation of communication services consumed by an organization from a plurality of communications service providers, the system comprising:
an invoices data store for information relating to communication services expenses of the organization from two or more service providers;
a services data store for information relating to services approved for use by the organization; and
an inventory data store for information relating to communications equipment in use by the organization,
wherein the system provides an interface for the tracking and presentation of the consumption of both wireless and wired communications services, including invoices, services and inventory associated with the wired and wireless communications services.

2. The system of claim 1, further comprising:
a reports data store for information relating to reports associated with communication services expenses of the organization,
wherein the system provides an interface for displaying one or more reports applicable to the consumption of both wireless and wired communications services.

3. The system of claim 2, wherein the system is further configured to provide an interface for building one or more reports applicable to the consumption of both wireless and wired communications services.

4. The system of claim 1, wherein the system is further configured to import at least one invoice from at least one of the plurality of communications services providers into said invoices data store.

5. The system of claim 4, wherein the system is further configured to receive electronic invoice information for the organization from a communications service and store the electronic invoice information in the invoices data store.

6. The system of claim 5, wherein the system is further configured to store the electronic invoice information in an electronic image format.

7. The system of claim 6, wherein the system is further configured to display at least one page of the electronic invoice information in response to user interaction to view that at least one page.

8. The system of claim 4, wherein the system is further configured to receive a paper based invoice for the organization from a communications services provider, extract electronic invoice information therefrom by character recognition, and store the electronic invoice information in the invoices data store.

9. The system of claim 8, wherein the system is further configured to store the electronic invoice information.

10. The system of claim 9, wherein the system is further configured to display at least one page of the electronic invoice information in the electronic image format in response to user interaction to view that at least one page.

11. The system of claim 4, wherein the system is further configured to determine electronic invoice information from the imported at least one invoice and convert at least a portion of the electronic invoice information from a first currency to a second currency.

12. The system of claim 4, wherein the system is further configured to determine electronic invoice information from the imported at least one invoice and convert at least a portion of the electronic invoice information from a first language to a second language.

13. The system of claim 1, wherein the system is further configured to provide an interface for requesting one or more of communication equipment, a communication accessory, maintenance, a new service, and a change of service.

14. The system of claim 1, wherein the system is further configured to provide an interface for displaying expenses associated with one or more of invoices, services, and inventory.

15. The system of claim 1, wherein the system is further configured to provide an interface for displaying trends of expenses associated with one or more of invoices, services, and inventory.

16. The system of claim 1, wherein the system is further configured to provide an interface for displaying one or more of used minutes and available minutes in turn associated with at least one member of the organization.

17. The system of claim 1, wherein the system is further configured to provide an interface for displaying one or more of used minutes and available minutes in turn associated with at least one communication services provider.

18. The system of claim 1, wherein the system is further configured to provide an interface for building a report applicable to the consumption of both wireless and wired communications services.

19. The system of claim 1, further comprising:
a user data store for information relating to at least one member of the organization that uses a communication service from at least one of the plurality of communications service providers.

20. The system of claim 1, wherein the system is further configured to provide a first interface for an organization member for viewing of one or more of invoices, services, and inventory specific to that member, and a second interface for an organization administrator for viewing one or more of invoices, services, and inventory applicable to plural members of the organization.

21. The system of claim 1, further comprising:
an orders data store for information relating to orders for communications equipment for use by the organization,
wherein the system is further configured to forward information associated with at least one order for approval of the order in response to a submission of the order.

22. A system for centralized tracking and presentation of communication services consumed by an organization from a plurality of communications service providers, the system comprising:
an invoices data store for information relating to communication services expenses of the organization from two or more service providers;
a services data store for information relating to services approved for use by the organization; and
an inventory data store for information relating to communications equipment in use by the organization,
wherein the system provides an interface for an organization member for viewing of one or more of invoices, services, and inventory specific to that member, and an interface for an organization administrator for viewing one or more of invoices, services and inventory applicable to plural members of the organization.

23. A system for centralized tracking and presentation of communication services consumed by an organization from a plurality of communications service providers, the system comprising
an invoices data store for information relating to communication services expenses of the organization from two or more service providers,
a services data store for information relating to services approved for use by the organization,
an inventory data store for information relating to communications equipment in use by the organization,
wherein the system is configured to import invoices from the plurality of communications services into said invoices data store, and the system further configured to receive first electronic invoice information for the organization from a first communications service and store the first electronic invoice information in the invoices data store associated with the organization.

24. The system of claim 23, wherein the system is further configured to receive a paper based invoice for the organization from a second communications service, extract second electronic invoice information therefrom by character recognition, and store the second electronic invoice information in the invoices data store associated with the organization.

25. A system for centralized tracking and presentation of communication services consumed by an organization from a plurality of communications service providers, the system comprising:
an invoices data store for information relating to communication services expenses of the organization from two or more service providers;
a services data store for information relating to services approved for use by the organization; and
an inventory data store for information relating to communications equipment in use by the organization,
wherein the system is configured to import invoices from the plurality of communications services into said invoices data store, the system further configured to receive a paper based invoice for the organization from a communications service, extract electronic invoice information therefrom by character recognition, and store the electronic invoice information in the invoices data store associated with the organization, the system further configured to generate an image for at least a portion of an imported paper based invoice that is relevant to a particular organization member for storage in said invoices data store.

26. The system of claim 25, wherein the system is further configured to generate a link to the image of the at least a portion of the imported paper based invoice that is relevant to the particular organization member.

27. The system of claim 26, wherein the system if further configured to display the image of the at least a portion of the imported paper based invoice that is relevant to the particular organization member in response to user interaction with the link.
